(19) United States
(12) Patent Application Publication
(10) Pub. No.: US 2023/0270164 A1
(43) Pub. Date: Aug. 31, 2023

(54) AEROSOL PROVISION DEVICE

(71) Applicant: Nicoventures Trading Limited, LONDON (GB)

(72) Inventors: Jon Peter Frederick SPRATLEY, Cambridgeshire (GB); Francesca Alys STEPHENS, Cambridgeshire (GB); Adam ROBINSON, Cambridgeshire (GB); Simon James COPLEY, Cambridgeshire (GB); Daniel Jerrad MOSS, Cambridgeshire (GB); Andy FINCH, Cambridgeshire (GB)

(21) Appl. No.: 18/040,727

(22) PCT Filed: Aug. 4, 2021
(86) PCT No.: PCT/EP2021/071796

§ 371 Date: Feb. 6, 2023

(30) Foreign Application Priority Data
Aug. 5, 2020 (GB) 2012177.8

(51) Int. Cl. A24F 40/40; A24F 40/20; A24D 1/20; F16C 11/04

(52) U.S. Cl. CPC A24F 40/40; A24F 40/20; A24D 1/20; F16C 11/04

(57) ABSTRACT

An aerosol provision device has an aerosol generator for generating aerosol from aerosol-generating material, a first coupling mechanism, a first part and a second part moveably restrained with respect to each other by the first coupling mechanism, and an accommodation zone, formed by the first part and the second part, for accommodating an article including, or for holding, the aerosol-generating material. The first part and the second part occupy a first volume when the device is in an unaccommodated state, and when the accommodation zone accommodates the article in an accommodated state of the aerosol provision device, the first part and the second part of the aerosol provision device together with the article occupy a second volume that is greater than the first volume.

### PRIORITY CLAIM

The present application is a National Phase entry of PCT Application No. PCT/EP2021/071796, filed Aug. 4, 2021, which claims priority from GB Application No. 2012177.8, filed Aug. 5, 2020, each of which hereby fully incorporated herein by reference.

### TECHNICAL FIELD

The present disclosure relates to aerosol provision devices, aerosol provision systems comprising an aerosol provision device, and methods of arranging an aerosol provision device.

### BACKGROUND

Smoking articles such as cigarettes, cigars and the like, burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

A first aspect provides an aerosol provision device. The aerosol provision device comprises an aerosol generator for generating aerosol from aerosol-generating material. The aerosol provision device comprises a first coupling mechanism. The aerosol provision device comprises a first part and a second part moveably restrained with respect to each other by the first coupling mechanism. The aerosol provision device comprises an accommodation zone, formed by the first part and the second part, for accommodating an article comprising, or for holding, the aerosol-generating material. The aerosol provision device is configured such that the first part and the second part together occupy a first volume when the aerosol provision device is arranged in an unaccommodated state. The aerosol provision device is further configured such that when the accommodation zone accommodates the article in an accommodated state of the aerosol provision device, the first part and the second part of the aerosol provision device together with the article occupy a second volume that is greater than the first volume.

In some embodiments, the first part and the second part are relatively moveable about a pivot. In some embodiments, the pivot is substantially parallel to a direction of a major dimension of the aerosol provision device. In some embodiments, the pivot is substantially parallel to a direction of a minor dimension of the aerosol provision device.

In some embodiments, the aerosol provision device comprises a hinge, wherein the hinge comprises the pivot. In other embodiments, the aerosol provision device comprises a flexible member, wherein the flexible member comprises the pivot.

In some embodiments, the aerosol provision device comprises a mechanism configured to bias the aerosol provision device towards the unaccommodated state by urging the first part and second part together. In some embodiments, wherein the first coupling mechanism comprises the mechanism. In some embodiments, the first coupling mechanism is configured to moveably restrain the article when the article is accommodated by the accommodation zone when the aerosol provision device is in the accommodated state.

In some embodiments, the aerosol provision device is configured to moveably restrain the article by a second coupling mechanism. In some embodiments, the second coupling mechanism comprises a coupling of a first portion of the first coupling mechanism with a first portion of the article. In some embodiments, the second coupling mechanism comprises a coupling of a second portion of the first coupling mechanism with a second portion of the article.

In some embodiments, the aerosol provision device is substantially annular. In some embodiments, the aerosol provision device is toroidal.

In some embodiments, when the article is accommodated by the accommodation zone when the aerosol provision device is in the accommodated state, the aerosol provision device and the article form an aerosol provision system, wherein the accommodation zone is located in a central region of the aerosol provision system. In some embodiments, the accommodation zone is located longitudinally of the aerosol provision system. In some embodiments, the accommodation zone is circular.

In some embodiments, the accommodation zone is variable in size, wherein the size of the accommodation zone is dependent on a relative position of the first part and the second part.

In some embodiments, the accommodation zone comprises an empty space between the first part and the second part when the device is in the unaccommodated state.

In some embodiments, the accommodation zone has a size that is negligible when the device is in the unaccommodated state compared to a size of the accommodation zone when the device is in the accommodated state.

In some embodiments, the first part and the second part are detachable from each other.

A second aspect provides an article for use with the aerosol provision device according to the first aspect. The article comprises, or holds, the aerosol-generating material.

A third aspect provides an aerosol provision system. The aerosol provision system comprises the aerosol provision device according to the first aspect and the article according to the second aspect.

A fourth aspect provides a method of forming an aerosol provision system. The method comprises providing an article comprising, or for holding, aerosol-generating material. The method comprises providing an aerosol provision device for accommodating the article, wherein the aerosol provision device comprises: an aerosol generator for generating aerosol from the aerosol-generating material; a first coupling mechanism; a first part; a second part; and an accommodation zone, formed by the first part and the second part, for accommodating the article. The method comprises restraining the first part and the second part with respect to each other by the first coupling mechanism such that the first part and second part together occupy a first volume in an unaccommodated state of the aerosol provision device. The method comprises accommodating the article in the accommodation zone in an accommodated state of the aerosol provision device, such that the first part and the second part of the aerosol provision device together with the article occupy a second volume that is greater than the first volume.

In some embodiments, the providing an aerosol provision device comprises providing the aerosol provision device according to the first aspect.

In some embodiments, the providing an article comprises providing the article according to the second aspect.

A fifth aspect provides an aerosol provision system. The aerosol provision system comprises an article comprising, or configured to hold, aerosol-generating material. The aerosol provision system comprises an aerosol provision device. The aerosol provision device comprises an aerosol generator for generating aerosol from the aerosol-generating material. The aerosol provision device comprises a minor dimension in a first direction. The aerosol provision system comprises a coupling mechanism configured to couple the aerosol provision device to the article. The aerosol provision system is configured such that when the article is coupled to the aerosol provision device by the coupling mechanism, a value of a dimension of the aerosol provision system in the first direction exceeds a value of the minor dimension of the aerosol provision device as a result of a presence of the article at one end of the minor dimension.

In some embodiments, the article is elongate.

In some embodiments, wherein the article is planar.

In some embodiments, the aerosol provision device is elongate.

In some embodiments, the aerosol provision device is planar.

In some embodiments, the minor dimension of the aerosol provision device is a width of the aerosol provision device.

In some embodiments, the minor dimension of the aerosol provision device is a thickness of the aerosol provision device.

In some embodiments, the coupling mechanism comprises two elements that are slidable against each other.

In some embodiments, the coupling mechanism comprises a snap fit mechanism. In some embodiments, the snap fit mechanism comprises a flexible protrusion engageable with a recess. In some embodiments, the aerosol provision device comprises the flexible protrusion and the article comprises the recess.

In some embodiments, the article comprises a major dimension in a third direction such that, when the article is coupled to the aerosol provision device, the third direction is perpendicular to the first direction. In some embodiments, the aerosol provision device and the article each comprise a longitudinal axis, wherein, when the article is coupled to the aerosol provision device, the longitudinal axis of the aerosol provision device is offset from the longitudinal axis of the article.

In some embodiments, the article comprises a major dimension in a third direction such that, when the article is coupled to the aerosol provision device, the third direction is parallel to the first direction.

In some embodiments, the article comprises a cross-section that varies along a major dimension of the article.

In some embodiments, the aerosol provision system is configured such that, when the article is coupled to the aerosol provision device, a value of a dimension of the aerosol provision system in a second direction perpendicular to the first direction is equal to a value of a major dimension of the aerosol provision device.

In some embodiments, the aerosol provision system is configured such that, when the article is coupled to the aerosol provision device, a value of a dimension of the aerosol provision system in a second direction perpendicular to the first direction is greater than or equal to a value of a dimension of the article in the second direction.

In some embodiments, the value of the dimension of the aerosol provision system in the first direction exceeds the value of the minor dimension of the aerosol provision device by an amount that is less than the value of the minor dimension.

In some embodiments, the value of the dimension of the aerosol provision system in the first direction exceeds the value of the minor dimension of the aerosol provision device by an amount that is greater than or equal to the value of the minor dimension. In some embodiments, the amount is at least twice the value of the minor dimension.

In some embodiments, the article comprises a plurality of discrete zones, wherein each of the plurality of discrete zones is configured to receive a discrete portion of the aerosol-generating material.

A sixth aspect provides an article for the aerosol provision system according to the fifth aspect. In some embodiments, the article comprises aerosol-generating material.

A seventh aspect provides an aerosol provision device. The aerosol provision device is couplable to at least one article according to the sixth aspect for forming the aerosol provision system according to the fifth aspect.

An eighth aspect provides a method of forming an aerosol provision system. The method comprises providing an article comprising, or configured to hold, aerosol-generating material. The method comprises providing an aerosol provision device couplable to the article and comprising an aerosol generator for generating aerosol from the aerosol-generating material, wherein the aerosol provision device comprises a minor dimension in a first direction. The method comprises coupling the aerosol provision device to the article by a coupling mechanism such that, a value of a dimension of the aerosol provision system in the first direction exceeds a value of the minor dimension of the aerosol provision device as a result of a presence of the article at one end of the minor dimension.

In some embodiments, the providing an article comprises providing the article according to the sixth aspect.

In some embodiments, the providing an aerosol provision device comprises providing the aerosol provision device according to the seventh aspect.

A ninth aspect provides a planar article for an aerosol provision device. The planar article comprises a storage portion comprising, or configured to receive, aerosol-generating material from which aerosol is to be generated by an aerosol generator of the aerosol provision device. The planar article comprises a coupling portion configured to become coupled with the aerosol provision device by a coupling mechanism to form an aerosol provision system. The planar article comprises an outer surface comprising a minor dimension and configured to form a portion of an exterior of the aerosol provision system. The planar article is configured such that when the article is coupled to the aerosol provision device by the coupling mechanism, the minor dimension of the article in a first direction is smaller than a dimension of the aerosol provision device in the first direction.

In some embodiments, the coupling portion is configured for sliding motion of the planar article relative to the aerosol provision device when the coupling mechanism couples the article to the aerosol provision device.

In some embodiments, the planar article is configured such that when viewing the planar article in the first direction, an outer edge of the planar article is arcuate. In some embodiments, the outer edge forms at least a part of a circle. In some embodiments, the planar article is a sector of a circle. In other embodiments, the planar article is disc-shaped.

In some embodiments, the planar article comprises a mouthpiece through which a user is able to draw the aerosol, in use.

In some embodiments, the minor dimension is a thickness of the planar article. In other embodiments, the minor dimension is a width of the planar article.

A tenth aspect provides an aerosol provision system. The aerosol provision system comprises a planar article comprising, or configured to receive, aerosol-generating material. The aerosol provision system comprises an aerosol generator for generating aerosol from the aerosol-generating material. The aerosol provision system comprises a coupling mechanism configured to couple the aerosol provision device to the article. The aerosol provision system is configured such that the article comprises an outer surface having a minor dimension and configured to form a portion of an exterior of the aerosol provision system, such that, when the article is coupled to the aerosol provision device by the coupling mechanism, the minor dimension of the article in a first direction is smaller than a dimension of the aerosol provision device in the first direction.

In some embodiments, the coupling mechanism comprises two elements that are slidable against each other. In some embodiments, the coupling mechanism comprises a snap fit mechanism.

In some embodiments, the aerosol provision device is elongate.

In some embodiments, the aerosol provision device is planar.

In some embodiments, the planar article is configured to occupy only a corner of the space occupied by the aerosol provision system.

In some embodiments, the planar article is configured to occupy a central region of the space occupied by the aerosol provision system.

In some embodiments, the planar article is configured to occupy a space between two separable portions of the aerosol provision device.

In some embodiments, the planar article is configured to occupy an entire length of the space occupied by the aerosol provision system.

In some embodiments, the planar article is configured to occupy a portion of an annular space occupied by the aerosol provision system.

In some embodiments, the planar article is wearable on a user when coupled to the aerosol provision device.

In some embodiments, the coupling mechanism is configured to couple the planar article away from a mouth end of the aerosol provision system. In some embodiments, the coupling mechanism is configured to couple the planar article at an end opposite the mouth end of the aerosol provision system.

In some embodiments, the planar article comprises a plurality of discrete zones, wherein each of the plurality of discrete zones is configured to receive a discrete portion of the aerosol-generating material.

In some embodiments, the aerosol provision system comprises a plurality of articles.

An eleventh aspect provides an aerosol provision device. The aerosol provision device is couplable to at least one planar article according to the ninth aspect for forming the aerosol provision system according to the tenth aspect.

A twelfth aspect provides a method of forming an aerosol provision system. The method comprises providing a planar article comprising, or configured to receive, aerosol-generating material from which aerosol is to be generated by an aerosol generator, wherein the planar article comprises an outer surface having a minor dimension and configured to form a portion of an exterior of the aerosol provision system. The method comprises providing an aerosol provision device couplable to the planar article by a coupling mechanism and comprising the aerosol generator. The method comprises coupling the aerosol provision device to the planar article such that the minor dimension of the planar article in a first direction is smaller than a dimension of the aerosol provision device in the first direction.

In some embodiments, the providing a planar article comprises providing the planar article according to the ninth aspect.

In some embodiments, the providing an aerosol provision device comprises providing the aerosol provision device according to the eleventh aspect.

A thirteenth aspect provides an aerosol provision device. The aerosol provision device comprises an aerosol generator configured to generate aerosol from aerosol-generating material. The aerosol provision device comprises a plurality of accommodation zones, wherein each one of the plurality of accommodation zones is configured to accommodate a discrete portion of aerosol-generating material. The aerosol provision device comprises a selector configured to select each discrete portion of aerosol-generating material. The aerosol provision device is configured such that the selector is moveable relative to the plurality of accommodation zones such that, when one of the discrete portions of aerosol-generating material is accommodated by the accommodation zone, the one of the discrete portions of aerosol-generating material is selectable by the selector for generation of aerosol from the one of the discrete portions of aerosol-generating material.

In some embodiments, each accommodation zone amongst the plurality of accommodation zones is fixed relative another of the accommodation zones.

In some embodiments, the plurality of accommodation zones is arranged circumferentially about an axis. In some embodiments, each accommodation zone amongst the plurality of accommodation zones is spaced apart with respect to an adjacent one of the accommodation zones. In some embodiments, the axis is an axis of the aerosol provision device. In some embodiments, each accommodation zone amongst the plurality of accommodation zones is configured to receive a cartridge comprising a discrete portion of aerosol-generating material. In some embodiments, the axis of the aerosol provision device is spaced apart from each cartridge.

In some embodiments, the axis of the aerosol provision device is an axis of rotational symmetry.

In some embodiments, the axis of the aerosol provision device is an axis about which the plurality of accommodation zones is moveable relative to the selector.

In some embodiments, the aerosol provision device comprises a plurality of cavities, wherein each accommodation zone amongst the plurality of accommodation zones corresponds to each cavity amongst the plurality of cavities.

In some embodiments, the plurality of accommodation zones is configured to receive a cartridge comprising a plurality of discrete portions of aerosol-generating material.

In some embodiments, the axis of the aerosol provision device is an axis of the cartridge. In some embodiments, the aerosol provision device is configured to allow rotation of the cartridge with respect to the aerosol provision device about the axis for selective interaction by the selector to select each discrete portion of aerosol-generating material.

In some embodiments, the axis of the cartridge is spaced apart from a longitudinal axis of the aerosol provision device.

In some embodiments, the aerosol provision device comprises a cavity comprising the plurality of accommodation zones.

A fourteenth aspect provides a cartridge. The cartridge is for use with the aerosol provision device according to the thirteenth aspect.

A fifteenth aspect provides an aerosol provision system. The aerosol provision system comprises the aerosol provision device according to the thirteenth aspect and the cartridge according to the fourteenth aspect.

A sixteenth aspect provides a cartridge. The cartridge is for accommodation by a cavity of an aerosol provision device. The cartridge comprises a plurality of storage portions each comprising, or for receiving, a discrete portion of aerosol-generating material. The cartridge comprises an engagement portion for engagement with a selector of the aerosol provision device. The cartridge comprises a rotational axis about which the cartridge is configured to rotate. The cartridge is configured such that, once accommodated by the cavity of the aerosol provision device, the plurality of storage portions are moveable relative to the selector of the aerosol provision device by rotation of the cartridge about the rotational axis such that one of the discrete portions of aerosol-generating material is selectable by the selector for generation of aerosol from the one of the discrete portions of aerosol-generating material.

In some embodiments, the plurality of storage portions is arranged circumferentially about an axis of the cartridge. In some embodiments, each storage portion amongst the plurality of storage portions comprises a longitudinal axis that is parallel to the axis of the cartridge.

In some embodiments, the cartridge comprises an outer surface such that, once accommodated by the cavity of the aerosol provision device to form an aerosol provision system, the outer surface forms an outer surface of the aerosol provision system.

In some embodiments, the cartridge is cylindrical.

A seventeenth aspect provides an aerosol provision system. The aerosol provision system comprises the aerosol provision device according to the thirteenth aspect and the cartridge according to the sixteenth aspect.

An eighteenth aspect provides a method of forming an aerosol provision system. The method comprises providing an aerosol provision device comprising an aerosol generator for generating aerosol from aerosol-generating material, and a selector configured to select a discrete portion of the aerosol-generating material. The method comprises accommodating the discrete portion of aerosol-generating material in one of a plurality of accommodation zones. The method comprises selectively moving the selector relative to the plurality of accommodation zones such that the discrete portion of aerosol-generating material is selected by the selector to generate aerosol from the discrete portion of aerosol-generating material.

In some embodiments, the accommodating comprises accommodating the discrete portion of aerosol-generating material in a cavity comprising one of the plurality of accommodation zones.

In some embodiments, the accommodating comprises accommodating the discrete portion of aerosol-generating material in a cavity comprising the plurality of accommodation zones.

In some embodiments, the providing an aerosol provision device comprises providing the aerosol provision device according to the thirteenth aspect.

A nineteenth aspect provides an aerosol provision system. The aerosol provision system comprises an article comprising, or for holding, aerosol-generating material. The aerosol provision system comprises an aerosol provision device in the shape of at least a portion of an annulus and comprising an aerosol generator for generating aerosol from the aerosol-generating material. The aerosol provision system comprises a coupling mechanism configured to couple the aerosol provision device to the article. The aerosol provision system is configured such that, when the aerosol provision device is coupled to the article, the article forms part of an external surface of the aerosol provision system.

In some embodiments, the aerosol provision device comprises an attachment portion for attaching to a user of the aerosol provision system. In some embodiments, the attachment portion is for attaching to a body part of the user. In some embodiments, the attachment portion is for attaching to an arm of the user. In some embodiments, the attachment portion is for attaching to a hand of the user. In some embodiments, the attachment portion is for attaching to a palm of the hand of the user.

In some embodiments, when the aerosol provision device is coupled to the article, the article is positioned with respect to the attachment portion to position the article in the palm of the hand of the user.

In some embodiments, when the aerosol provision device is coupled to the article, the article is positioned with respect to the attachment portion to position the article to a back of the hand of the user.

In some embodiments, the article closes the annulus when the aerosol provision device is coupled to the article.

In some embodiments, the aerosol provision device is in the shape of a closed annulus and the article is couplable to an edge of the annulus.

In some embodiments, when the aerosol provision device is coupled to the article, the article occupies at least some of a central space surrounded by the annulus.

In some embodiments, when the aerosol provision device is coupled to the article, the article occupies an entire central region surrounded by the annulus.

In some embodiments, the article is disc-shaped.

In some embodiments, the aerosol provision device comprises a housing comprising two respectively movable parts.

In some embodiments, the aerosol provision device comprises a housing comprising a first part and a second part that is detachable from the first part.

In some embodiments, the article comprises a plurality of discrete zones, wherein each of the plurality of discrete zones is configured to receive a discrete portion of the aerosol-generating material.

A twentieth aspect provides an article for the aerosol provision system according to the nineteenth aspect.

In some embodiments, the article comprises aerosol-generating material.

A twenty-first aspect provides an aerosol provision device couplable to at least one article according to the twentieth aspect for forming the aerosol provision system according to the nineteenth aspect.

A twenty-second aspect provides a method of forming an aerosol provision system. The method comprises providing an article comprising, or for holding, aerosol-generating material. The method comprises providing an aerosol provision device in the shape of an annulus and comprising an aerosol generator for generating aerosol from the aerosol-generating material. The method comprises coupling the aerosol provision device to the article such that the article forms part of an external surface of the aerosol provision system.

In some embodiments, the providing an article comprises providing the article according to the twentieth aspect.

In some embodiments, the providing an aerosol provision device comprises providing the aerosol provision device according to the twenty-first aspect.

A twenty-third aspect provides an aerosol provision system. The aerosol provision system comprises an article comprising, or for holding, aerosol-generating material. The aerosol provision system comprises an aerosol provision device couplable to the article and comprising an aerosol generator for generating aerosol from the aerosol-generating material. The aerosol provision system is configured such that, when viewed in a first direction, the aerosol provision system occupies a first space formed of a plurality of substantially equal spaces, and the article occupies a second space corresponding to a majority portion of one of the plurality of substantially equal spaces, wherein the first space has an order of rotational symmetry greater than two.

In some embodiments, when coupled to the aerosol provision device, the article overlies an exact position of one of the plurality of substantially equal spaces of the aerosol provision system.

In some embodiments, a total number of the plurality of substantially equal spaces is less than or equal to the order of rotational symmetry.

In some embodiments, a dimension of the article measured in the first direction is different to a corresponding dimension of the aerosol provision device.

In some embodiments, a dimension of the article measured in the first direction is greater than a corresponding dimension of the aerosol provision device.

In some embodiments, a dimension of the article measured in the first direction is less than a corresponding dimension of the aerosol provision device.

In some embodiments, a dimension of the article measured in the first direction is equal to a corresponding dimension of the aerosol provision device.

In some embodiments, when viewed in the first direction, the aerosol provision device occupies a third space that is substantially equal to the first space.

In some embodiments, when viewed in the first direction, the aerosol provision device occupies a third space that substantially corresponds to the first space absent the second space.

In some embodiments, the aerosol provision system is symmetrical with respect to a plane through an axis for defining the order of rotational symmetry.

In some embodiments, the first space is arcuate. In some embodiments, the first space is a circle. In some embodiments, the first space is an annulus.

In some embodiments, the first space is a regular polygon.

In some embodiments, the first space is octagonal.

In some embodiments, the article comprises a plurality of discrete zones, wherein each of the plurality of discrete zones is configured to receive a discrete portion of the aerosol-generating material.

In some embodiments, the aerosol provision system comprises a plurality of second spaces and a plurality of articles, wherein each one of the second spaces is occupied by a respective one of the plurality of articles.

A twenty-fourth aspect provides an article for the aerosol provision system according to the twenty-third aspect.

In some embodiments, the article comprises aerosol-generating material.

A twenty-fifth aspect provides an aerosol provision device couplable to at least one article according to the twenty-fourth aspect for forming an aerosol provision system according to the twenty-third aspect.

A twenty-sixth aspect provides a method of forming an aerosol provision system. The method comprises providing an article comprising, or for holding, aerosol-generating material. The method comprises providing an aerosol provision device couplable to the article and comprising an aerosol generator for generating aerosol from the aerosol-generating material. The method comprises coupling the aerosol provision device to the article such that, when viewed in a first direction, the aerosol provision system occupies a first space formed of a plurality of substantially equal spaces, and the article occupies a second space corresponding to a majority portion of one of the plurality of substantially equal spaces, wherein the first space has an order of rotational symmetry greater than two.

In some embodiments, the providing an article comprises providing the article according to the twenty-fourth aspect.

In some embodiments, the providing an aerosol provision device comprises providing the aerosol provision device according to the twenty-fifth aspect.

Further features and advantages of the disclosure will become apparent from the following description of various embodiments, given by way of example only, which is made with reference to the accompanying drawings.

### BRIEF DESCRIPTION OF THE DRAWINGS

Embodiments of the disclosure will now be described, by way of example only, with reference to accompanying drawings, in which:

FIG. 1a shows a perspective view of an aerosol provision device.

FIGS. 1b and 1c each show a perspective view of an aerosol provision system comprising the aerosol provision device of FIG. 1a.

FIG. 1d shows various electrical components of the aerosol provision device shown in FIGS. 1a to 1c.

FIG. 2a shows a perspective view of an aerosol provision device.

FIGS. 2b and 2c each show a perspective view of an aerosol provision system comprising the aerosol provision device of FIG. 2a.

FIG. 3a shows a perspective view of an aerosol provision device.

FIGS. 3b and 3c each show a perspective view of an aerosol provision system comprising the aerosol provision device of FIG. 3a.

FIG. 4 shows a method of forming an aerosol provision system.

FIGS. 5a and 5b each show a perspective view of an aerosol provision system.

FIG. 6a shows a perspective view of an aerosol provision system.

FIG. 6b shows a schematic front view of the aerosol provision system of FIG. 6a.

FIG. 7 shows a perspective view of an aerosol provision device.

FIG. 8 shows a perspective view of an aerosol provision system.

FIGS. 9a and 9b each show a perspective view of an aerosol provision system.

FIG. 9c shows a schematic front view of the aerosol provision system of FIGS. 9a and 9b.

FIG. 10 shows a perspective view of an aerosol provision system.

FIG. 11 shows a perspective view of an aerosol provision system.

FIG. 12a shows a perspective view of an aerosol provision system.

FIG. 12b shows a schematic front view of the aerosol provision system of FIG. 12a.

FIGS. 13a and 13b each show a perspective view of an aerosol provision system.

FIG. 14 shows a perspective view of an aerosol provision system.

FIGS. 15a and 15b each show a front view of an aerosol provision system.

FIGS. 16 to 34 show schematic perspective views of aerosol provision systems.

FIGS. 35 to 39 show methods of forming aerosol provision systems.

### DETAILED DESCRIPTION

The present disclosure relates to aerosol provision devices, such as non-combustible aerosol provision devices, and to aerosol provision systems, such as non-combustible aerosol provision systems. According to the present disclosure, a “non-combustible” aerosol provision device is one where a constituent aerosol-generating material comprised by a consumable for receipt by a chamber of the aerosol provision device (or component thereof) is not combusted or burned in order to facilitate delivery of the aerosol-generating material to a user. In some embodiments, the aerosol provision system, such as the non-combustible aerosol provision system, comprises an aerosol provision device, such as a non-combustible aerosol provision device, and a consumable for use with the aerosol provision device, the consumable comprising an aerosol-generating material.

In some embodiments, the non-combustible aerosol provision system is a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. The aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some cases, the aerosol-generating material comprises from about 50 wt %, 60 wt % or 70 wt % of amorphous solid, to about 90 wt %, 95 wt % or 100 wt % of amorphous solid. In some cases, the aerosol-generating material consists of amorphous solid.

The aerosol-generating material may comprise one or more active substances and/or flavors, one or more aerosol-former materials, and optionally one or more other functional materials.

In some embodiments, a substance to be delivered by the aerosol provision device may be an aerosol-generating material which may comprise an active constituent, a carrier constituent and optionally one or more other functional constituents.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

In some embodiments, the consumable for use with the aerosol provision device may comprise aerosol-generating material or an area for receiving aerosol-generating material. The area for receiving aerosol-generating material may be a storage area for storing aerosol-generating material. For example, the storage area may be a reservoir. In some embodiments, the area for receiving aerosol-generating material may be separate from, or combined with, an aerosol generating area.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision device may comprise an area for receiving the consumable, an aerosol generator, an aerosol generation area, a housing, a mouthpiece, a filter and/or an aerosol-modifying agent.

A user may insert the consumable into the aerosol provision device before an aerosol is produced, which the user subsequently inhales. The consumable may be, for example, of a predetermined or specific size that is configured to be placed within a chamber, such as a heating chamber, of the device which is sized to receive the consumable.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

In some embodiments, the substance to be delivered may comprise one or more active constituents, one or more flavors, one or more aerosol-former materials, and/or one or more other functional materials. The one or more other functional materials may comprise one or more of pH regulators, coloring agents, preservatives, binders, fillers, stabilizers, and/or antioxidants.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy. The aerosol generator may be provided as a permanent part of the aerosol provision device.

Apparatus is known that heats aerosol-generating material to volatilize at least one component of the aerosol-generating material, typically to form an aerosol which can be inhaled, without burning or combusting the aerosol-generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol-generating material in the form of a liquid, which may or may not contain nicotine. The aerosol-generating material may be in the form of or be provided as part of a rod, cartridge or cassette or the like which can be inserted into the apparatus.

A user of an aerosol provision device will store the aerosol provision device in a storage, such as a pocket or a bag, when aerosol is not being drawn through the aerosol provision device. The user will then remove the aerosol provision device from the storage before configuring the aerosol provision device ready for a usage session when aerosol is drawn from the device or the device is cleaned. Interaction by the user with the aerosol provision device comprises physically adjusting the aerosol provision device to a state suitable for the usage session. Aerosol provision systems, aerosol provision devices, and articles for use with the aerosol provision device are provided that offer improved setup functionality and/or reduced storage demands. This provides a more discrete presence of the aerosol provision systems, aerosol provision devices, and articles. Furthermore, the aerosol provision systems, aerosol provision devices, and articles may be easier to interact with (for example, hold) when in use.

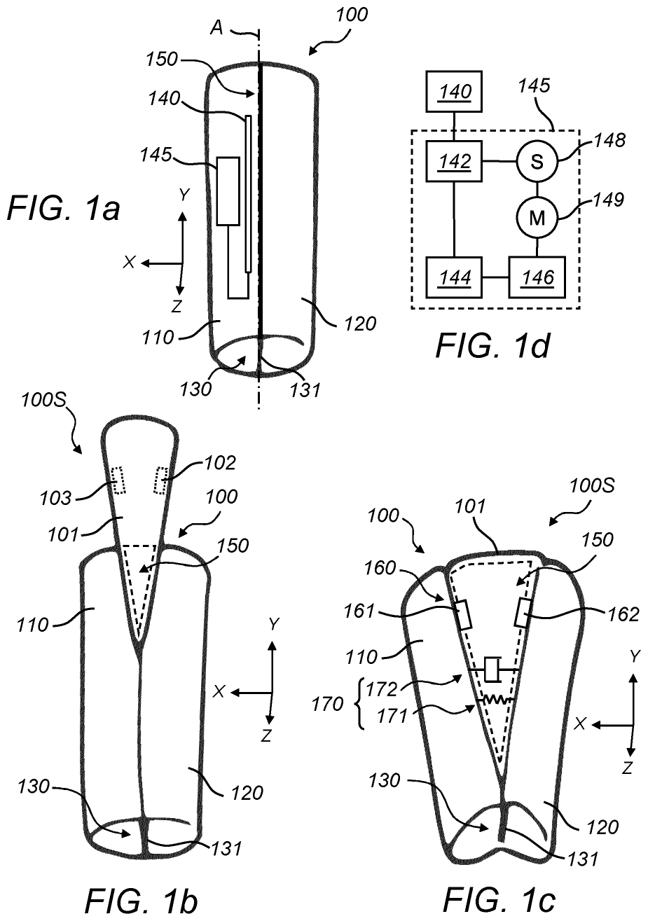

FIG. 1a shows an aerosol provision device 100 for generating an inhalable medium. FIGS. 1b and 1c show an aerosol provision system 100S comprising the aerosol provision device 100 of FIG. 1a and an article 101 comprising, or for holding, aerosol-generating material.

The aerosol provision device 100 comprises a first part 110 and a second part 120. Each of the first part 110 and the second part 120 is a body. Together, the first part 110 and the second part 120 form a casing of the aerosol provision device 100. That is, each of the first part 110 and the second part 120 may be referred to as a casing member. In this embodiment, the first part 110 is shown to comprise components of the aerosol provision device 100. The first part 110 is therefore a housing. In other embodiments, the second part 120 may also comprise components of the aerosol provision device 100 and therefore also be referred to as a housing.

The first part 110 and the second part 120 are moveably restrained with respect to each other by a first coupling mechanism 130. The first coupling mechanism 130 retains the first part 110 to the second part 120 whilst allow relative movement between the first part 110 and the second part 120. In this embodiment, the coupling mechanism 130 is a hinge comprising a pivot 131. The first part 110 and the second part 120 are relatively moveable about the pivot 131. An axis of the pivot 131 is arranged in a depth direction Z of the aerosol provision device 100. In this embodiment, the axis of the pivot 131 is perpendicular to a longitudinal axis A of the aerosol provision device 100. In other embodiments, the axis of the pivot 131 may be arranged in a width (transverse) direction X or a length (longitudinal) direction Y of the aerosol provision device 100. The aerosol provision device 100 comprises a major dimension in the length direction Y and minor dimensions in the width direction X and the depth direction Z. In this embodiment, when the aerosol provision device 100 is in a closed state (shown by FIG. 1a), values of the minor dimensions of the aerosol provision device 100 are equal. In this embodiment, the pivot 131 is parallel to a direction of the minor dimension of the aerosol provision device 100, wherein the minor dimension referred to is the depth direction Z.

The aerosol provision device 100 comprises an accommodation zone 150. The accommodation zone 150 is located longitudinally of the aerosol provision system 100S. The accommodation zone 150 is formed by the first part 110 and the second part 120. The accommodation zone 150 is configured to accommodate the article 101 comprising aerosol-generating material. In other embodiments, the article 101 is for holding the aerosol-generating material. The accommodation zone 150 may be referred to as a chamber. The accommodation zone 150 is located between the first part 110 and the second part 120 and is formed by the first part 110 and the second part 120. The accommodation zone 150 is located longitudinally of the aerosol provision device 100 and the aerosol provision system 100S. The accommodation zone 150 is located centrally of the aerosol provision device 100 and the aerosol provision system 100S.

In this embodiment, the article 101 is insertable into the accommodation zone 150 via an end of the aerosol provision device 100. In other embodiments, the article 101 may be insertable into the accommodation zone 150 via a side of the aerosol provision device 100. Once inserted, the article 101 is configured to occupy the accommodation zone 150. In embodiments, once inserted, the article 101 may be configured to fully, partially or at least partially occupy the accommodation zone 150. In this embodiment, the accommodation zone 150 is configured so that the article 101 abuts walls of the accommodation zone 150, as defined by the first part 110 and second part 120. In this embodiment, the article 101 is wedge-shaped in the longitudinal direction Y. That is, the article 101 narrows from one end to another end in the longitudinal direction Y.

In this embodiment, the aerosol provision device 100 comprises an interface (not shown) configured to engage with the article 101 to retain the article 101 at a predetermined position in the accommodation zone 150. In this embodiment, the interface is a second coupling mechanism 160. The second coupling mechanism 160 is configured to moveably restrain the article 101. The second coupling mechanism 160 moveably restrains the article 101 by resistance to movement of the article 101. The second coupling mechanism 160 comprises a coupling of portions of the aerosol provision device 100 to corresponding portions of the article 101. That is, the second coupling mechanism 160 comprises a coupling of a first portion 161 of the aerosol provision device 100 with a first portion 103 of the article 101. In this embodiment, the first part 110 comprises the first portion 161 of the second coupling mechanism 160. Furthermore, the second coupling mechanism 160 comprises a coupling of a second portion 162 of the aerosol provision device 100 with a second portion 102 of the article 101. In this embodiment, the second part 120 comprises the second portion 162 of the second coupling mechanism 160. The second coupling mechanism 160 may be referred to as a retention mechanism, whereby the first portion 161 and the second portion 162 of the second coupling mechanism 160 are retention members.

In this embodiment, the accommodation zone 150 is variable in size and therefore variable in volume. In other embodiments, the accommodation zone 150 may comprise a fixed size and therefore fixed volume. The size of the accommodation zone 150 is dependent on a relative position of the first part 110 and the second part 110. The accommodation zone 150, shown in FIG. 1a, is provided in a collapsed state with a minimum size (minimum volume). The collapsed state of the accommodation zone 150 corresponds to an unaccommodated state of the aerosol provision device 100. The accommodation zone 150, shown in FIG. 1c, is provided in an expanded state with a maximum size (maximum volume). The expanded state of the accommodation zone 150 corresponds to an accommodated state of the aerosol provision device 100 when the article 101 is in the accommodation zone 150. In this embodiment, the accommodation zone 150 has a size that is negligible when the aerosol provision device 100 is in the unaccommodated state compared to a size of the accommodation zone 150 when the aerosol provision device 100 is in the accommodated state.

The first part 110 and the second part 120 together occupy a first volume when the aerosol provision device 100 is arranged in an unaccommodated state, as shown in FIG. 1a. When the accommodation zone 150 accommodates the article 101 in an accommodated state of the aerosol provision device 100, as shown in FIG. 1c, the first part 110 and the second part 120 of the aerosol provision device 100, together with the article 101, occupy a second volume that is greater than the first volume. Advantageously, the aerosol provision device 100 is more compact when arranged in the unaccommodated state, than when the aerosol provision device 100 is arranged in the accommodated state. Beneficially the aerosol provision device 100 reduces storage space requirements allowing the user to discreetly store the aerosol provision device 100.

The aerosol provision device 100 comprises an aerosol generator 140 for generating an inhalable medium, such as aerosol, from the aerosol-generating material of the article 101 when the article 101 is in the accommodation zone 150. In this embodiment the accommodation zone 150 comprises an aerosol generation zone. In this embodiment, the aerosol generator 140 is configured to supply heat to the aerosol-generating material of the article 101 to generate the inhalable medium. In this embodiment, the aerosol generator 140 comprises an electrical resistance heater. In other embodiments, the aerosol generator 140 may comprise an induction heater or one or more of an electrical resistance heater and an induction heater. In yet other embodiments, pressure, or vibration could be used to generate an inhalable medium from the article 101, for example.

In the embodiment shown in FIGS. 1a, 1b, and 1c, the aerosol generator 140 is positioned to one side of the accommodation zone 150 and extends along a length of the accommodation zone 150 in the longitudinal direction of the aerosol provision device 100 when the aerosol provision device 100 is arranged in the unaccommodated state. The aerosol generator 140 is shown in the first part 110 of the aerosol provision device 100 and is absent the second part 120 of the aerosol provision device 100. In other embodiments, the aerosol generator 140 may be arranged on opposite sides of the accommodation zone 150 and be present in both the first part 110 of the aerosol provision device 100 and the second part 120 of the aerosol provision device 100. In other embodiments, the aerosol generator 140 may extend only partially along the accommodation zone 150 and/or may be positioned elsewhere relative to the accommodation zone 150.

The aerosol provision device 100 comprises an electrical control zone 145. The electrical control zone 145 refers to the electrical components of the aerosol provision device 100 except for the aerosol generator 140. Such electrical components are shown in FIG. 1d and are briefly discussed below. Other aerosol provision devices discussed below also comprise an electrical control zone and features of the electrical control zone are common across these aerosol provision devices.

FIG. 1d shows various electrical components of the aerosol provision device 100. The electrical control zone 145 comprises a power source 142. The power source 142 is configured to supply power to the electrical resistance heater. In some embodiments, the power source 142 is a rechargeable battery. The rechargeable battery may be integral to the aerosol provision device. In other embodiments, the power source 142 may be replaceable, such as a replaceable battery. In other embodiments, the power source may be a non-rechargeable battery. The power source 142 is configured to provide electrical power to electronic components of the aerosol provision device.

The electrical control zone 145 comprises a detector 146 to detect insertion of the article 101 into the accommodation zone 150. In some embodiments, the detector 146 may detect a relative position of the first part 110 and the second part 120 to drive a driving mechanism to control the relative position of the first part 110 and the second part 120. In some embodiments, two detectors 146 may be provided, wherein one detector detects a relative position of the first part 110 and the second part 120 and another detector detects insertion of the article 101 into the accommodation zone 150.

The electrical control zone 145 comprises a controller 144 for controlling the aerosol generator 140 and a motor 149 to optionally control a relative position of the first part 110 and the second part 120. In this embodiment, a user can operate a switch 148 to turn operation of the motor 149 on or off. In other embodiments, the switch 148 may be configured to turn operation of the detector 146 on or off. The switch 168 is manually operable and is configured to send an electronic signal to the controller 160 to allow the motor 149 to be enabled or disabled. When the detector 146 is turned off by the switch 148, the first part 110 and the second part 120 may move by manual operation the first part 110 and the second part 120. When the motor 149 is turned on, the first part 110 and the second part 120 moves by operation of the motor 149. When the motor 149 is turned on, the controller 144 is configured to receive an output from the detector 146 and cause the motor 149 to drive movement of either the first part 110 and/or the second part 120 between the unaccommodated state and the accommodated state of the aerosol provision device 100.

In this embodiment, the switch 148 is a push switch. In other embodiments, the switch 148 is a sliding switch. In some embodiments, the switch 148 does not require movement to be imparted by the user on the switch 148 to operate the switch 148. For example, the switch 148 may comprise capacitive sensing to sense a presence of the user.

In this embodiment, the controller 144 is configured to activate the aerosol generator 140 once the detector 146 has detected the presence of the article 101 in the accommodation zone 150. When the switch 148 is turned on, the controller 144 is configured to activate the aerosol generator 140 once the detector 146 has detected a relative position of the first part 110 and/or the second part 120, such as a relative position when the aerosol provision device 100 is in an accommodated state. The relative movement of the first part 110 and/or the second part 120 can therefore be on the basis of the output from the detector 146. In some embodiments, activation of the aerosol generator 140 by the controller 144 is immediate. In other embodiments, activation of the aerosol generator 140 by the controller 144 is delayed by a predetermined time. The detector 146, the controller 144, the motor 149, and the aerosol generator 140 are each powered by the power source 142.

In this embodiment, withdrawal of the article 101 from the accommodation zone 150, which leads to an absence of the article 101 from the aerosol provision device 100, is additionally detectable by the detector 146. Therefore, removing the article 101 from the accommodation zone 150 is also configured to disable the aerosol generator 140. When the motor 149 is turned on by the switch 148, removing the article 101 from the accommodation zone 150 is may alternatively or additionally be configured to control a relative position of the first part 110 and/or the second part 120, for example, the aerosol provision device 100 may return to the unaccommodated state. That is, the controller 144 is configured to receive an output from the detector 146 to detect an absence of the article 101 in the accommodation zone 150 and cause the motor 149 to drive movement of the first part 110 and/or the second part 120 relative to each other from the accommodated state to the unaccommodated state of the aerosol provision device 100.

Referring to FIG. 1c, the aerosol provision device 100 comprises a mechanism 170 configured to bias the aerosol provision device 100 towards the unaccommodated state by urging the first part 110 and second part 120 together. The mechanism 170 is configured to control movement of the first part 110 and the second part 120 from the unaccommodated state of the aerosol provision device 100, as shown in FIG. 1a, to the accommodated state of the aerosol provision device 100, as shown in FIG. 1c. The mechanism 170 comprises a biasing member 171 and a damper 172. Although the mechanism 170 is shown away from the first coupling mechanism, in this some embodiment, the first coupling mechanism 130 comprises mechanism 170. In other embodiments, the mechanism 170 may be provided elsewhere on the aerosol provision device 100.

In some embodiments, the mechanism 170 may comprise only one of the biasing member 171 or damper 172. The biasing member 171 is configured to bias the aerosol provision device 100 to the unaccommodated state and the damper 172 is configured to control a speed at which the aerosol provision device 100 moves to the unaccommodated state. That is, the damper 172 dampens movement of the aerosol provision device 100 to the unaccommodated state. The biasing member 171 resists movement of the first part 110 relative to the second part 120 in order to reduce a time that the aerosol provision device 100 is in the position of the accommodated state when an article 101 is not in the accommodation zone 150. Advantageously, the biasing member 171 and damper 172 provide controlled relative movement of the first part 110 and second part 120.

Although the biasing member 171 and damper 172 are shown together in this embodiment, in other embodiments, one of the biasing member 171 and damper 172 may be used at once. Further, the biasing member 171 and/or damper 172 may be applied to other embodiments discussed herein, even if no mechanism 170 is otherwise referred to or shown in the corresponding figures.

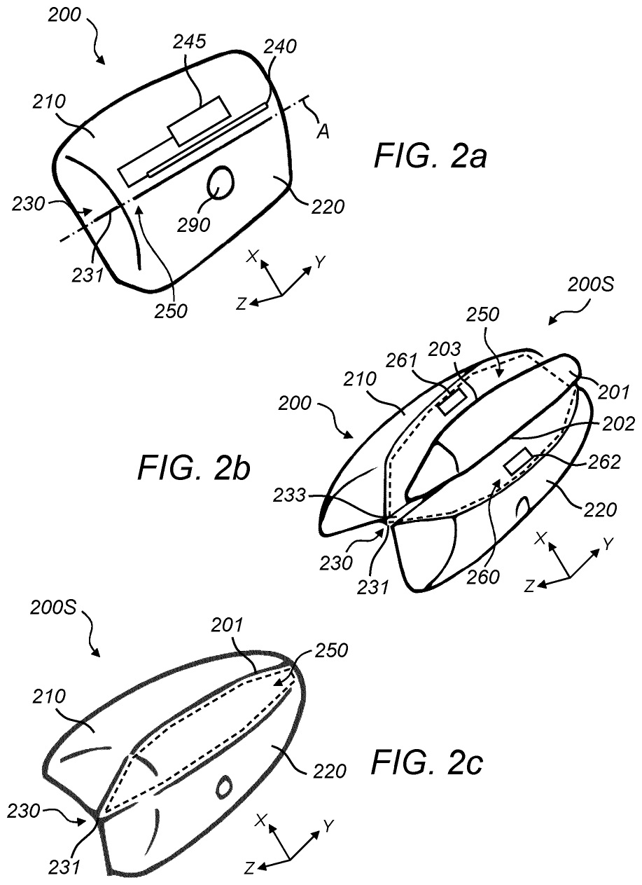

FIG. 2a shows an aerosol provision device 200. FIGS. 2b and 2c show an aerosol provision system 200S comprising the aerosol provision device 200 of FIG. 2a and an article 201 comprising, or for holding, aerosol-generating material. Similar components in the aerosol provision device 200 have the same reference numbers as those of FIGS. 1a to 1d but the reference numbers are increased by 100. Such common features are not discussed again. The discussion of the aerosol provision system 200 below is limited to the differences. The aerosol provision device 200 may comprise features discussed previously that are compatible with the aerosol provision device 200 but are not shown in FIGS. 2a to 2c. Non-exhaustive examples include a damping mechanism, a detector, a controller, a motor, a power source, and a switch.

In this embodiment, a first part 210 and a second part 120 are moveably restrained with respect to each other by a first coupling mechanism 230. In this embodiment, the first coupling mechanism 230 comprises a flexible member 233. The flexible member 233 comprises a pivot 231. An axis of the pivot 231 is arranged in a length direction Y of the aerosol provision device 200. In this embodiment, the axis of the pivot 231 is parallel to a longitudinal axis A of the aerosol provision device 200. In other embodiments, the axis of the pivot 231 may be arranged in a width (transverse) direction X or a depth direction Z of the aerosol provision device 200. The aerosol provision device 200 comprises a major dimension in the length direction Y and minor dimensions in the width direction X and the depth direction Z, the most minor dimension being the width direction X. In this embodiment, the pivot 231 is parallel to a direction of the major dimension of the aerosol provision device 200, and perpendicular to the minor dimensions of the aerosol provision device 200.

In this embodiment, an article 201 is insertable into an accommodation zone 250 via a side of the aerosol provision device 200. The accommodation zone 250 is located longitudinally of the aerosol provision system 200S. Once inserted, the article 201 is configured to occupy the accommodation zone 250. In this embodiment, the accommodation zone 250 is configured so that the article 201 abuts walls of the accommodation zone 250, as defined by the first part 210 and second part 220. In this embodiment, the article 201 is wedge-shaped in the width (transverse) direction X. That is, the article 201 narrows from one side to another side in the width direction X.

The first part 210 and the second part 220 together occupy a first volume when the aerosol provision device 200 is arranged in an unaccommodated state shown in FIG. 2a. When the accommodation zone 250 accommodates the article 201 in an accommodated state of the aerosol provision device 200, shown in FIG. 2c, the first part 210 and the second part 220 of the aerosol provision device 200, together with the article 201, occupy a second volume that is greater than the first volume.

The aerosol provision device 200 comprises a button 290 to release the first part 210 from the second part 210. The button 290 enables a decoupling of a first portion 261 of the aerosol provision device 200 with a second portion 262 of the aerosol provision device 200. The first portion 261 and the second portion 262 are part of a second coupling mechanism 260, as previously explained in relation aerosol provision device 100.

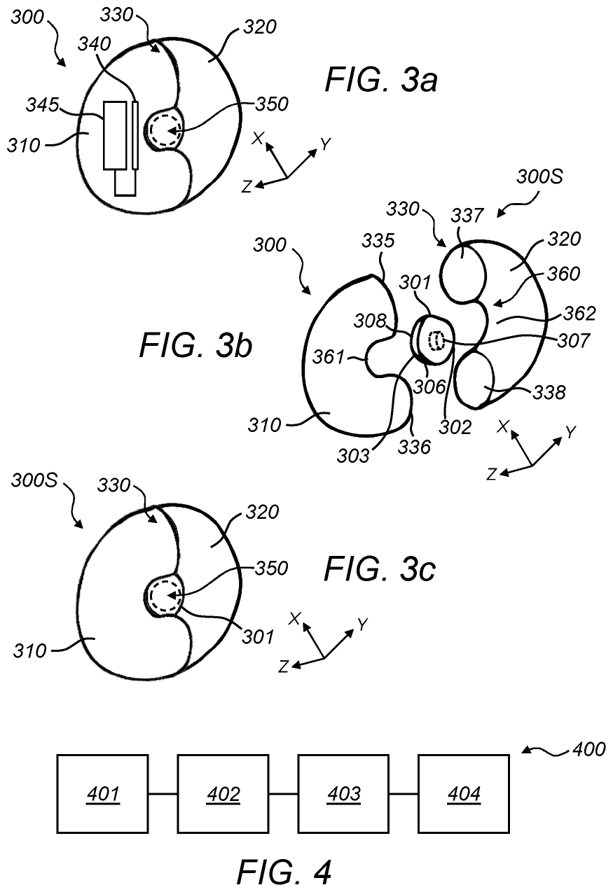

FIG. 3a shows an aerosol provision device 300. FIGS. 3b and 3c show an aerosol provision system 300S comprising the aerosol provision device 300 of FIG. 3a and an article 301 comprising, or for holding, aerosol-generating material. Similar components in the aerosol provision device 300 have the same reference numbers as those of previous Figures but the reference numbers are increased by a multiple of 100. Such common features are not discussed again. The discussion of the aerosol provision system 300 below is limited to the differences. The aerosol provision device 300 may comprise features discussed previously that are compatible with the aerosol provision device 300 but are not shown in FIGS. 3a to 3c. Non-exhaustive examples include a damping mechanism, a detector, a controller, a motor, a power source, and a switch.

In this embodiment, a first part 310 and a second part 320 of the aerosol provision device 300 are moveably restrained with respect to each other by a first coupling mechanism 330. The first coupling mechanism 330 comprises a first portion 335 and a second portion 336 of the first part 310. The first coupling mechanism 330 comprises a first portion 337 and a second portion 338 of the second part 320. The first portion 335 and second portion 336 of the first part 310 are configured to couple with and decouple from the respective first portion 337 and second portion 338 of the second part 320. That is, the first part 310 and the second part 320 are detachable from each other to separate. The first portions 335, 337 may be decoupled while the second portions 336, 338 remain coupled. This allows the first part 310 and the second part 320 to be moveably restrained with respect to each other. In some embodiments, the first portions 335, 337 and/or second portions 336, 338 may comprises a pivot to allow rotation of the first part 310 and second part 320 relative to each other. In other embodiments, the first part 310 and the second part 320 may be immovably restrained with respect to each other such that decoupling of either the first portions 335, 337 or the second portions 336, 338 prevents relative movement between the first part 310 and the second part 320.

The aerosol provision device 300 is configurable between an unaccommodated state (FIG. 3a) and an accommodated state (FIG. 3c). The first part 310 and the second part 320 have the same position relative to each other in both the unaccommodated state and the accommodated state of the aerosol provision device 300. In this embodiment, an accommodation zone 350 has a fixed size. That is, the accommodation zone 350 has a size in the unaccommodated state that is the same as a size of the accommodation zone 350 in the accommodated state. When the aerosol provision device 300 is in the unaccommodated state, the accommodation zone 350 is an empty space. On the other hand, the empty space is occupied by the article 301, when the aerosol provision device 300 is in the accommodated state.

To accommodate the article 301 in the accommodation zone 350, at least one of the first portions 335, 337 and the second portions 336, 338 are first decoupled. In this embodiment, both the first portions 335, 337 and second portions 336, 338 are decoupled, as shown in FIG. 3b. Either a first portion 303 or a second portion 302 of the article 301 then abuts a corresponding first portion 361 or a second portion 362 of a second coupling mechanism 360 of the aerosol provision device 300 before the other portions come together and abut each other. The article 301 is then held firmly by the first part 310 and second part 320. That is, when the first part 310 is coupled to the second part 320 and the article 301 is in the accommodation zone 350, the aerosol provision device 300 is in an accommodated state, shown in FIG. 3c. In this embodiment, the first portion 361 and the second portion 362 comprise localized curvature to complement a curvature of an outer edge of the article 301. In other embodiments, the first portion 361 and the second portion 362 may comprise grooves to receive the outer edge of the article 301.

In this embodiment, the aerosol provision device 300 is toroidal and the accommodation zone 350 is a circular space at a central region of the toroidal aerosol provision device 300. When coupled to the aerosol provision device 300, the article 301 occupies the entire central region surrounded by the toroidal aerosol provision device 300. Each of the first part 310 and the second part 320 forms part of the toroid. In this embodiment, the first part 310 and the second part 320 each form half of the toroid. In other embodiments, the first part 310 and the second part 320 may each form a different amount of the toroid. In some embodiments, the accommodation zone 350 may be a space with a different two-dimensional shape, such as a triangle, square, pentagon, or hexagon. In some embodiments, the region of the accommodation zone 350 may be a region that is offset from a center of the aerosol provision device 300.

The aerosol provision device 300 comprises major dimensions in the width direction X and the length direction Y and a minor dimension in the depth direction Z. In this embodiment, when the aerosol provision device 300 is in either an unaccommodated state (shown by FIG. 3a) or an accommodated state (shown by FIG. 3c), values of the major dimensions of the aerosol provision device 300 are equal.

In this embodiment, the article 301 is a planar article 301 in the form of a disc. That is, the planar article 301 is disc-shaped. The planar article 301 comprises a storage portion 307 comprising, or configured to receive, aerosol-generating material from which aerosol is to be generated by an aerosol generator 340 of the aerosol provision device 300. The planar article 301 comprises an outer surface 306 comprising a minor dimension in a depth direction Z. The outer surface 306 is configured to form a portion of an exterior of the aerosol provision system 300S, as shown in FIG. 3c. The planar article 301 is configured such that when the planar article 301 is coupled to the aerosol provision device 300 by the second coupling mechanism 360, the minor dimension of the article in the depth direction Z is smaller than a dimension of the aerosol provision device 300 in the depth direction Z. That is, in this embodiment, a thickness of the planar article 301 is smaller than a thickness of the aerosol provision device 300, as shown by FIG. 3b.

FIG. 4 shows an illustration of a method 400 of forming an aerosol provision system. The method 400 comprises providing 401 an article comprising, or for holding, aerosol-generating material. The method 400 comprises providing 402 an aerosol provision device for accommodating the article. The aerosol provision device comprises: an aerosol generator for generating aerosol from the aerosol-generating material; a first coupling mechanism; a first part; a second part; and an accommodation zone, formed by the first part and the second part, for accommodating the article. The method 400 comprises restraining 403 the first part and the second part with respect to each other by the first coupling mechanism such that the first part and second part together occupy a first volume in an unaccommodated state of the aerosol provision device. The method 400 comprises accommodating 404 the article in the accommodation zone in an accommodated state of the aerosol provision device, such that the first part and the second part of the aerosol provision device together with the article occupy a second volume that is greater than the first volume.

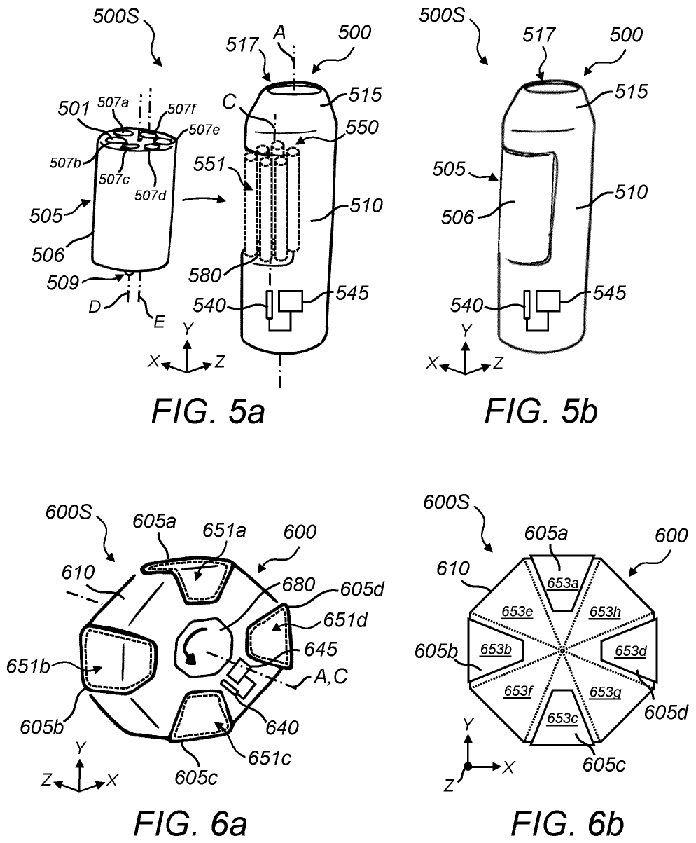

FIGS. 5a and 5b show an aerosol provision system 5005. The aerosol provision system 5005 comprises an aerosol provision device 500 and a cylindrical cartridge 505 for accommodation by a cavity 551 of the aerosol provision device 500. Similar components in the aerosol provision device 500 and aerosol provision system 5005 have the same reference numbers as those of previous Figures but the reference numbers are increased by a multiple of 100. Such common features are not discussed in detail again. The discussion of the aerosol provision system 5005 below is limited to the differences. The aerosol provision device 500 may comprise features discussed previously that are compatible with the aerosol provision device 500 but are not shown in FIGS. 5a and 5b. Non-exhaustive examples include a damping mechanism, a detector, a controller, a motor, a power source, and a switch.

The aerosol provision device 500 comprises a body 510. The cavity 551 is formed in the body 510 and is for receiving the cartridge 505. The cartridge 505 is configured to revolve about the body 510 so that discrete portions of aerosol generating material can be selected and deselected.

The aerosol provision device 500 comprises a mouthpiece 515. The mouthpiece 515 comprises an opening 517 through which aerosol can be drawn through the mouthpiece 515 by a user of the aerosol provision device 500. The mouthpiece 515 is arranged at a mouth end of the aerosol provision device 500. The mouth end can be referred to as a buccal end.

When the cartridge 505 is unloaded from the cavity 551, the aerosol provision system 5005 is said to be in an unaccommodated state, as shown in FIG. 5a. When the cartridge 505 is loaded in the cavity 551, the aerosol provision system 5005 is said to be in an accommodated state, as shown in FIG. 5b.

The aerosol provision device 500 comprises six accommodation zones 550. The six accommodation zones 550 are circumferentially arranged around a central axis C. Each accommodation zone 550 is spaced apart with respect to an adjacent one of the accommodation zones 550. In this embodiment, the six accommodation zones 550 are fixed relative to one another. Furthermore, each of the six accommodation zones 550 is fixed relative to the body 510 of the aerosol provision device 500. In this embodiment, each accommodation zone 550 is cylindrical. Each accommodation zone 550 is longitudinally aligned with a longitudinal axis A of the aerosol provision device 500. That is, each accommodation zone 550 and the aerosol provision device 500 extends in the length direction Y of the aerosol provision system 5005. In other embodiments, the aerosol provision device 500 may comprise a different number of accommodation zones 550. Each one of the six accommodation zones 550 is configured to accommodate a discrete portion of aerosol-generating material. In this embodiment, the article 501 comprises the discrete portion of aerosol-generating material. The article 501 is shown loaded in the cartridge 505 in FIG. 5a.

The aerosol provision device 500 comprises a selector 580 configured to select each article 501 and thus select each discrete portion of aerosol-generating material. The selected article 501 can be used to generate aerosol by an aerosol generator 540 of the aerosol provision device 500 when the aerosol generator 540 is activated. The aerosol provision device 500 is configured such that the selector 580 is moveable relative to the six accommodation zones 550 to allow the article 501 to be selectable by the selector 580 for generation of aerosol from the discrete portions of aerosol-generating material. In this embodiment, the selector 580 is configured to engage and disengage the cartridge 505 to allow the article 501 in the cartridge 505 to be positioned in each of the six accommodation zones 550 by rotation of the cartridge 505 about an axis D. That is, each of the six storage portions 507a-f can be aligned with each of the six accommodation zones 550. In this embodiment, the cartridge 505 comprises an engagement portion 509 for engagement with the selector 580 of the aerosol provision device 500. The selector 580 engages and disengages with the engagement portion 509 to prevent or allow rotation of the cartridge 505 in the cavity 551 of the aerosol provision device 500.

In this embodiment, the cartridge 505 comprises six storage portions 507a-f. Each of the six storage portions 507a-f receives a discrete portion of aerosol-generating material in the form of an article 501. In this embodiment, one article 501 comprising aerosol-generating material is shown in one storage portion 507b. In other embodiments, the storage portion 507b may be comprised of a discrete portion of aerosol-generating material without the article 501. In this embodiment, each one of the storage portions 507a-f is cylindrical and comprises a longitudinal axis E. Each one of the storage portions 507a-f is longitudinally aligned with a longitudinal axis A of the aerosol provision device 500. That is, each one of the storage portions 507a-f and the aerosol provision device 500 extends in the length direction Y of the aerosol provision system 5005. In other embodiments, the cartridge 505 may comprise a different number of storage portions 507a-f.

The cartridge 505 comprises an outer surface 506 that forms part of an outer surface of the aerosol provision system 5005 when the aerosol provision system 5005 is arranged in the accommodated state, as shown in FIG. 5b. As the cartridge 505 revolves in the cavity 551 of the aerosol provision device 500, a portion of the outer surface 506 is concealed while another portion is visible to a user. The portion that is concealed is concealed by the body 510 of the aerosol provision device 500.

In this embodiment, the aerosol provision system 5005 is rotationally symmetric, wherein the axis of the aerosol provision device 500 is an axis of rotational symmetry of the aerosol provision system 5005.

When the aerosol provision system 5005 is arranged in the accommodated state, the axis of the cartridge D and the axis of the aerosol provision device A are parallel to each other and offset from each other. This allows the cartridge 501 to spin at one side of the aerosol provision system 5005. Advantageously, a user can grip the body 510 and move the cartridge D to a desired position so that the article 501 can be selected. Movement of the cartridge 505 about body 510 can be governed by a motor rather than by manual operation.

FIGS. 6a and 6b show an aerosol provision system 600S. The aerosol provision system 600S comprises an aerosol provision device 600 and four cartridges 605a-d each for accommodation by one of four cavities 651a-d of the aerosol provision device 600. Similar components in the aerosol provision device 600 and aerosol provision system 600S have the same reference numbers as those of previous Figures but the reference numbers are increased by a multiple of 100. Such common features are not discussed in detail again. The discussion of the aerosol provision system 600S below is limited to the differences. The aerosol provision device 600 may comprise features discussed previously that are compatible with the aerosol provision device 600 but are not shown in FIGS. 6a and 6b. Non-exhaustive examples include a damping mechanism, a detector, a controller, a motor, a power source, and a switch.

The aerosol provision device 600 comprises a body 610. The four cavities 651a-d are formed in the body 610 and are for receiving each one of four cartridges 605a-d. Each one of the four cavities 651a-d provides an accommodation zone for accommodating a cartridge 605a-d. The cartridges 605a-d are configured to revolve about a selector 680 so that discrete portions of aerosol generating material can be selected and deselected by the selector 680. The aerosol generating material in the selected cartridge 605a-d is then generated into aerosol by an aerosol generator 640 of the aerosol provision device 600 when the aerosol generator 640 is activated.

When a cartridge 605a-d is unloaded from the respective cavity 651a-d, the aerosol provision system 600S is said to be in an unaccommodated state. When the cartridge 605a-d is loaded in the respective cavity 651a-d, the aerosol provision system 600S is said to be in an accommodated state, as shown in FIG. 6a.

The four cavities 651a-d of the aerosol provision device 600 are circumferentially arranged around a central axis C. Each one of four cavities 651a-d is spaced apart with respect to an adjacent one of the four cavities 650a-d. In this embodiment, the four cavities 651a-d are fixed relative to one another. Furthermore, each of the four cavities 651a-d is fixed relative to the body 610 of the aerosol provision device 600. In this embodiment, each of the four cavities 651a-d has a constant cross-section. In this embodiment, the constant cross-section is in the shape of a trapezoid. In other embodiments, the constant cross-section may have a different shape. In yet other embodiments, the cross-section may not be constant.

In other embodiments, the aerosol provision device 600 may comprise a different number of cavities 651a-d. Each one of the four cavities 651a-d is configured to indirectly accommodate a discrete portion of aerosol-generating material by directly accommodating a cartridge 605a-d. In this embodiment, the discrete portion of aerosol-generating material is loaded into each cartridge 605a-d.

The aerosol provision device 600 comprises a selector 680 configured to select each cartridge 605a-d and thus select each discrete portion of aerosol-generating material. The selected cartridge 605a-d can be used to generate aerosol by an aerosol generator 640 of the aerosol provision device 600 when the aerosol generator 640 is activated. The aerosol provision device 600 is configured such that the selector 680 is rotatable relative to the four cavities 651a-d to allow each cartridge 605a-d to be selectable by the selector 680 for generation of aerosol from the discrete portions of aerosol-generating material. In this embodiment, the selector 680 is configured to engage and disengage the cartridges 605a-d by rotation of the selector 680 about a longitudinal axis A of the aerosol provision device 600. In other embodiments, an axis of the selector 680 may be different to the longitudinal axis A of the aerosol provision device 600.

In this embodiment, each cartridge 605a-d comprises a single storage portion. Each storage portion receives a discrete portion of aerosol-generating material, which may be in the form of an article. In this embodiment, the storage portion is comprised of a discrete portion of aerosol-generating material without the article. In other embodiments, one article comprising aerosol-generating material may be inserted in one storage portion. In other embodiments, the cartridge may be an article comprising aerosol-generating material.

Each cartridge 605a-d comprises an outer surface that forms part of an outer surface of the aerosol provision system 600S when the aerosol provision system 600S is arranged in the accommodated state, as shown in FIG. 6a.

In this embodiment, the aerosol provision system 600S is rotationally symmetric, wherein the axis of the aerosol provision device 600 is an axis of rotational symmetry of the aerosol provision system 600S.

Referring to FIG. 6b, the aerosol provision system 600S is configured such that, when viewed in the depth direction Z, the aerosol provision system 600S occupies a first space formed of a plurality of substantially equal spaces 653a-h. In this embodiment, the first space is an octagon. Therefore, each of the plurality of substantially equal spaces 653a-h is one of eight triangles. Each of the eight triangles combine to form the octagon. When viewed in the depth direction Z, each cartridge 605a-d is a trapezoid and occupies a second space 653a-d, within each of the eight triangles. Each second space corresponds to a majority portion of each triangle. When viewed in the depth direction, Z, the aerosol provision device 600 occupies a space that substantially corresponds to the first space (e.g. the octagon) absent the second space (e.g. the trapezoid).

As shown in FIG. 6a, a thickness of each cartridge 605a-d, as measured in the depth direction Z, is greater than a thickness of the aerosol provision device 600. In other embodiments, the thickness of each cartridge 605a-d may be greater than or equal to the thickness of the aerosol provision device 600.

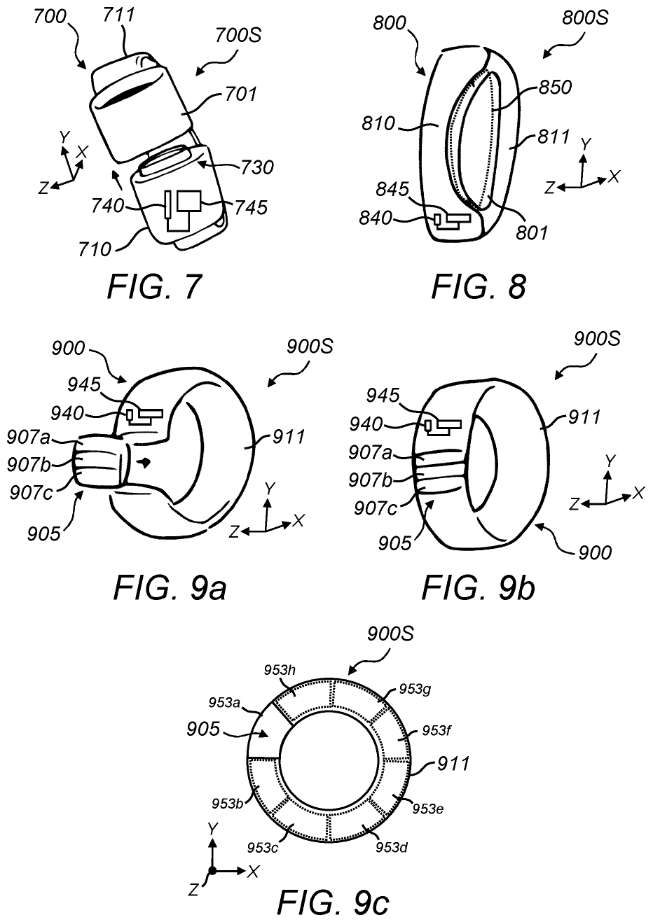

FIGS. 7-11 show aerosol provision systems 700S, 800S, 900S, 1000S, 1100S. Each of aerosol provision systems 700S, 800S, 900S, 1000S, 1100S comprises an aerosol provision device 700, 800, 900, 1000, 1100 and either an article 701, 801, 1001, 1101 or a cartridge 905. When the article 701, 801, 1001, 1101 or cartridge 905 is coupled to the aerosol provision device 700, 800, 900, 1000, 1100, the aerosol provision system 700S, 800S, 900S, 1000S, 1100S is in the form of an annulus when viewing the aerosol provision systems 700S, 800S, 900S, 1000S, 1100S in the depth direction Z. Similar components in the aerosol provision devices 700, 800, 900, 1000, 1100 and aerosol provision systems 700S, 800S, 900S, 1000S, 1100S have the same reference numbers as those of previous Figures but the reference numbers are increased by a multiple of 100. Such common features are not discussed in detail again. The discussion of the aerosol provision systems 700S, 800S, 900S, 1000S, 1100S below is limited to the differences. The aerosol provision devices 700, 800, 900, 1000, 1100 may comprise features discussed previously that are compatible with the aerosol provision devices 700, 800, 900, 1000, 1100 but are not shown in FIGS. 7-11. Non-exhaustive examples include a damping mechanism, a detector, a controller, a motor, a power source, and a switch.

In FIGS. 7, 8, 10 and 11, the aerosol provision systems 700S, 800S, 1000S, 1100S each comprise an article 701, 801, 1001, 1101 comprising aerosol-generating material. In other embodiments, the article 701, 801, 1001, 1101 may be holding aerosol-generating material. In FIG. 9, the aerosol provision system 900S comprises a cartridge 905 comprising three discrete zones 907a-c, wherein each of the three discrete zones 907a-c is configured to receive a discrete portion of aerosol-generating material. In other embodiments, the cartridge 905 may be an article comprising three discrete zones.

In FIGS. 7, 9a-c, and 10, the aerosol provision systems 700S, 900S, 1000S each comprise an aerosol provision device 700, 900, 1000 in the shape of a portion of an annulus. In FIGS. 8 and 11, the aerosol provision systems 800S, 11005 each comprise an aerosol provision device 800, 1100 in the shape of an annulus.

The aerosol provision systems 700S comprises a coupling mechanism 730 configured to couple the aerosol provision device 700 to the article 701. Although not shown in the Figures, aerosol provision systems 800S, 900S, 1000S, 1100S also comprise a coupling mechanism for coupling the article 801, 1001, 1101 or cartridge 901 to the respective device 800, 900, 1000, 1110. The aerosol provision systems 700S, 800S, 1000S, 1100S are configured such that, when the respective aerosol provision device 700, 800, 1000, 1100 is coupled to the article 701, 801, 1001, 1101 or cartridge 901, the article 701, 801, 1001 or cartridge 901 forms part of an external surface of the aerosol provision system 700S, 800S, 1000S, 1100S.

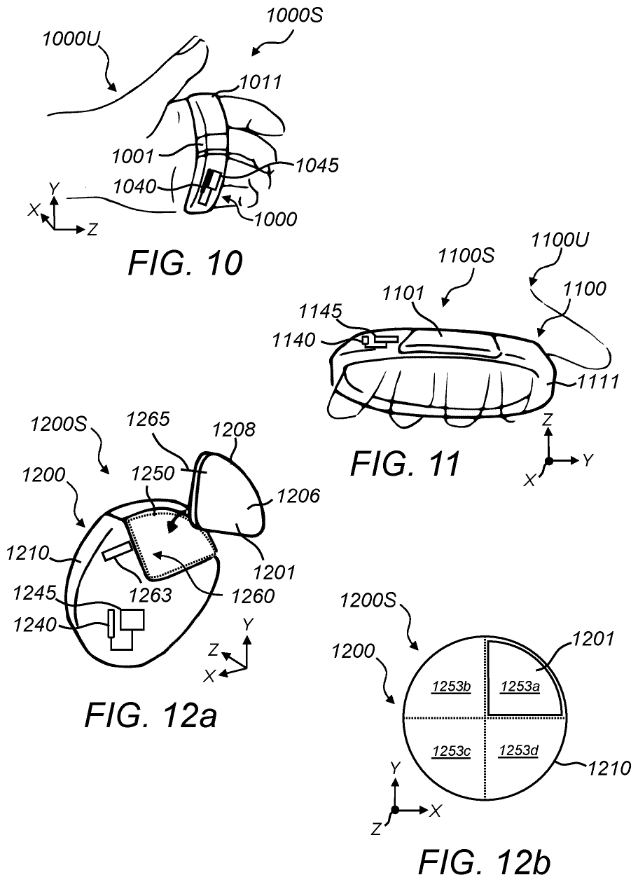

Each of the aerosol provision devices 700, 800, 900, 1000, 1100 comprises an attachment portion 711, 811, 911, 1011, 1111 for attaching to a user 1000U, 1100U of the aerosol provision systems 700S, 800S, 900S, 1000S, 1100S. As shown in FIGS. 10 and 11, the attachment portion 1011, 1111 is for attaching to a palm of the user 1000U, 1100U. In FIG. 10, the aerosol provision device 1000 is coupled to the article 1001 and the article 1001 is positioned with respect to the attachment portion 1011 to position the article 1001 in the palm of the user 1000U. In FIG. 11, the aerosol provision device 1111 is coupled to the article 1101 and the article 1101 is positioned with respect to the attachment portion 1111 to position the article 1101 to a back of the hand of the user 1100U.

In FIGS. 7, 9a-c and 10, the aerosol provision devices 700, 900, 1000 are in the form of an open annulus. That is, the aerosol provision systems 700S, 900S, 1000S are configured to receive the respective article 701, 1001, or cartridge 905, to close the portion of the annulus formed by the respective aerosol provision devices 700, 900, 1000 when the respective aerosol provision devices 700, 900, 1000 are coupled to the respective article 701, 1001, or cartridge 905.

In FIGS. 8 and 11, the aerosol provision devices 800, 1100 are in the shape of a closed annulus. The respective article 801, 1101 is couplable to an outer edge or an outer face of the annulus, respectively. An accommodation zone 850 for receiving the article 801 of aerosol provision device 800 is shown in FIG. 8. The accommodation zone 850 is located laterally to one side of the aerosol provision device 800 in both the depth direction Z and the width direction X.

In FIGS. 7 and 8, the aerosol provision devices 700, 800 comprise a body 710, 810 to house an aerosol generator 740, 840 and an electrical control zone 745, 845. In FIGS. 9, 10 and 11 an aerosol generator 940, 1040, 1140 and an electrical control zone 945, 1045, 1145 is housed by the respective attachment portion 911, 1011, 1111. Each attachment portion 711, 811, 911, 1011, 1111 is a flexible component that is able to provide a secure fit when worn by the user. In contrast, the body 710, 810 is a rigid component having a form that is less flexible than the flexible component. This allows a location of the article 701, 801 to be well controlled.

Referring to FIG. 9c, the aerosol provision system 900S is configured such that, when viewed in the depth direction Z, the aerosol provision system 900S occupies a first space formed of a plurality of substantially equal spaces 953a-h. In this embodiment, the first space is an annulus, as also demonstrated by FIG. 9b. Therefore, each of the plurality of substantially equal spaces 953a-h is one of eight portions of the annulus. Each of the eight portions combine to form the annulus. When viewed in the depth direction Z, the cartridge 905 is a portion of the annulus that occupies a second space 953a. That is, when coupled to the aerosol provision device 900, the cartridge 905 overlies an exact position of one of the portions of the annulus of the aerosol provision system 900. The second space corresponds to a majority portion of the portion of the annulus. When viewed in the depth direction, Z, the aerosol provision device 900 occupies a space that substantially corresponds to the first space (e.g. the annulus) absent the second space (e.g. the portion of the annulus), as demonstrated by FIG. 9a.

As shown in FIG. 9b, a thickness of the cartridge 905, as measured in the depth direction Z, is equal to a thickness of the aerosol provision device 900. In other embodiments, the thickness of the cartridge 905 may be less than or greater than the thickness of the aerosol provision device 900. In other embodiments, the cartridge may be an article comprising aerosol-generating material.

The cartridge 905 of aerosol provision device 900, which may also be an article 905, comprises three discrete zones 907a-c, as shown in FIGS. 9a and 9b. The three discrete zones 907a-c are fixed relative to each other and couplable as a whole to the attachment portion 911 of the aerosol provision device 900. Each of the three discrete zones 907a-c is configured to receive a discrete portion of aerosol-generating material. Each of the three discrete zones 907a-c is elongate with a length in the depth direction Z. In other embodiments, two discrete zones 907a-c or more than three discrete zones 907a-c may be provided.

Similar the aerosol provision system 900S in FIGS. 9a-c, the aerosol provision system 1000S in FIG. 10c is configured such that, when viewed in the depth direction Z, the aerosol provision system 1000S occupies a first space formed of a plurality of substantially equal spaces. In this embodiment, the first space is also an annulus. Therefore, each of the plurality of substantially equal spaces is one of many equal portions of the annulus. Each of the equal portions combines to form the annulus. When viewed in the depth direction Z, the article 1001 is a portion of the annulus that occupies a second space. That is, when coupled to the aerosol provision device 1000, the article 1001 overlies an exact position of one of the many equal portions of the annulus of the aerosol provision system 1000. The second space corresponds to a majority portion of an equal portion of the annulus. When viewed in the depth direction, Z, the aerosol provision device 1000 occupies a space that substantially corresponds to the first space (e.g. the annulus) absent the second space (e.g. an equal portion of the annulus).

As shown in FIG. 10, a thickness of the article 1001, as measured in the depth direction Z, is equal to a thickness of the aerosol provision device 1000. In other embodiments, the thickness of the article 1001 may be greater less than or greater to the thickness of the aerosol provision device 1000. In other embodiments, the cartridge may be an article comprising aerosol-generating material.

FIGS. 12a and 12b show an aerosol provision system 1200S. The aerosol provision system 1200S comprises an aerosol provision device 1200 and an article 1201. Similar components in the aerosol provision device 1200 and aerosol provision system 1200S have the same reference numbers as those of previous Figures but the reference numbers are increased by a multiple of 100. Such common features are not discussed in detail again. The discussion of the aerosol provision system 1200S below is limited to the differences. The aerosol provision device 1200 may comprise features discussed previously that are compatible with the aerosol provision device 1200 but are not shown in FIGS. 12a and 12b. Non-exhaustive examples include a damping mechanism, a detector, a controller, a motor, a power source, and a switch.

In this embodiment, the aerosol provision system 1200S is substantially planar and disc shaped. The article 1201 forms a sector of the disc-shaped aerosol provision system 1200S and comprises part of an overall thickness of the aerosol provision system 1200S, as measured in the depth direction Z. That is, a body 1210 comprises an accommodation zone 1250 that is a sector of the disc-shaped aerosol provision system 1200S to be filled by the article 1201 when the article 1201 is coupled to the body 1210 by a coupling mechanism 1260. The body 1210 houses an aerosol generator 1240 and an electrical control zone 1245.

As shown in FIG. 12a, the article 1201 is a planar article. That is, a thickness of the article 1201 (as measured in the depth direction Z) is significantly small compared to a width (as measured in the width direction X) and length (as measured in the length direction Y) of the article 1201. The planar article 1201 comprises a storage portion comprising aerosol-generating material from which aerosol is to be generated by the aerosol generator 1240. The planar article 1201 comprises a coupling portion 1265 configured to become coupled with the aerosol provision device 1200 by a coupling mechanism 1260 to form the aerosol provision system 1200S. The planar article comprises an outer surface 1206 configured to form a portion of an exterior of the aerosol provision system 1200S. When the planar article 1201 is coupled to the aerosol provision device 1200 by the coupling mechanism 1260, the thickness of the planar article 1201 in the depth direction Z is smaller than a dimension of the aerosol provision device 1200 in the depth direction Z. In fact, the aerosol provision device 1200 is stepped and comprises two thickness, both of which are greater than the thickness of the planar article 1201.

In this embodiment, the coupling mechanism 1260 comprises two elements 1263, 1265 that are slidable against each other. In other embodiments, the coupling mechanism 1260 may comprises a snap fit mechanism.

The planar article 1201 is a portion of a disc and comprises an outer edge 1208 that forms a sector of a circle. That is, the planar article 1201 forms a corner of a space occupied by the aerosol provision system 1200S.

Referring to FIG. 12b, the aerosol provision system 1200S is configured such that, when viewed in the depth direction Z, the aerosol provision system 1200S occupies a first space formed of a plurality of substantially equal spaces 1253a-d. In this embodiment, the first space is a circle. Therefore, each of the plurality of substantially equal spaces 1253a-h is a quadrant. Each of the four quadrants combines to form the circle. When viewed in the depth direction Z, the article 1201 is itself a quadrant and occupies a second space 1253a, within each of the four quadrants of the first space. That is, when coupled to the aerosol provision device 1200, the article 1201 overlies an exact position of one of the quadrants of the aerosol provision system 1200. Each second space corresponds to a majority portion of each of the four quadrants of the first space. When viewed in the depth direction, Z, the aerosol provision device 1200 occupies a space that substantially corresponds to the first space (e.g. the circle) absent the second space (e.g. the quadrant of the article).

As shown in FIG. 12a, a thickness of the article 1201, as measured in the depth direction Z, is less than a thickness of the aerosol provision device 1200. In other embodiments, the thickness of the article 1201 may be greater than or equal to the thickness of the aerosol provision device 1200. In other embodiments, the article may be a cartridge for receiving an article.

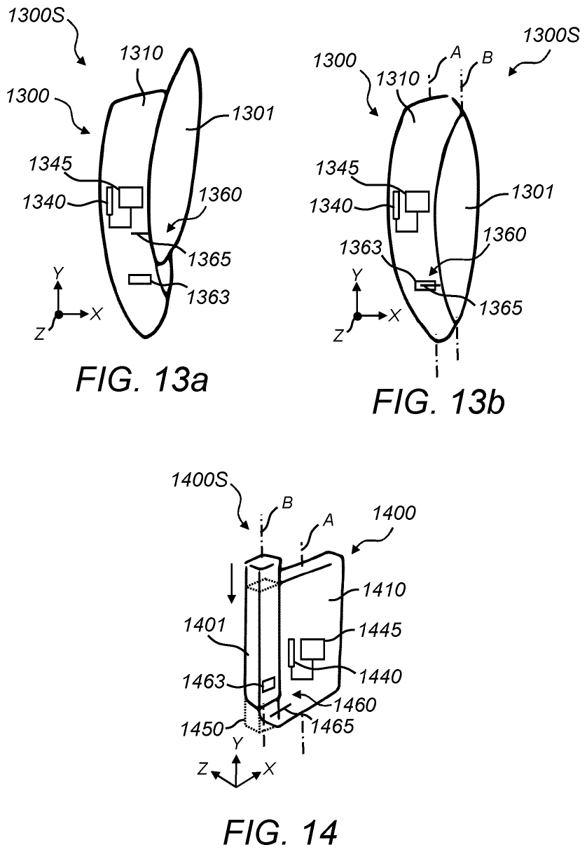

FIGS. 13a, 13b, and 14 show aerosol provision systems 1300S, 1400S. The aerosol provision systems 1300S, 1400S comprises aerosol provision devices 1300, 1400 and elongate articles 1301, 1401. Similar components in the aerosol provision devices 1300, 1400 and aerosol provision system 1300S, 1400S have the same reference numbers as those of previous Figures but the reference numbers are increased by a multiple of 100. Such common features are not discussed in detail again. The discussion of aerosol provision systems 1300S, 1400S below is limited to the differences. The aerosol provision devices 1300, 1400 may comprise features discussed previously that are compatible with the aerosol provision devices 1300, 1400 but are not shown in FIGS. 13a, 13b and 14. Non-exhaustive examples include a damping mechanism, a detector, a controller, a motor, a power source, and a switch.

Both aerosol provision devices 1300, 1400 comprise coupling mechanisms 1360, 1460. The coupling mechanisms 1360, 1460 comprise snap fit mechanisms. The snap fit mechanisms comprise a flexible protrusion 1365, 1465 engageable with a recess 1363, 1463. In aerosol provision device 1400, the article comprises the recess 1463 and the aerosol provision device 1400 comprises the flexible protrusion 1465. In aerosol provision device 1300, the article comprises flexible protrusion 1365 and the aerosol provision device 1300 comprises the recess 1363.

The articles 1301, 1401 are slidable along the respective bodies 1310, 1410 to engage with and couple to the respective bodies 1310, 1410. As shown in FIG. 14, an accommodation zone 1450 is to receive the article 1401 of aerosol provision systems 1400S. The accommodation zone 1450 is arranged to one side of the aerosol provision device 1400. This is also the case for aerosol provision device 1300. That is, the articles 1301, 1401 comprise longitudinal axes B that are offset from longitudinal axes A of the respective aerosol provision devices 1300, 1400.

Referring to FIGS. 13a, 13b and 14, the aerosol provision devices 1300, 1400 comprise a minor dimension in a first direction, corresponding to the width direction X. When the articles 1301, 1401 are coupled to the aerosol provision devices 1300, 1400 by the coupling mechanisms 1360, 1460, a width of the aerosol provision systems 1300S, 1400S exceed a width of the aerosol provision devices 1300, 1400 as a result of a presence of the article 1301, 1401 at one end of the width of the aerosol provision devices 1300, 1400. The articles 1301, 1401 each comprise alength in a third direction, corresponding to the longitudinal direction Y. When the articles 1301, 1401 are coupled to the respective aerosol provision devices 1300, 1400, the third direction is perpendicular to the first direction.

The article 1301 comprises the same length and depth as the aerosol provision device 1300 but a different width. The article 1401 comprises a different width, depth and length to the aerosol provision device 1400.

In the aerosol provision system 1300S, the article 1301 comprises a cross-section that varies along a length of the article 1301. In contrast, in the aerosol provision system 1400S, the article 1401 comprises a constant cross-section along a length of the article 1401.

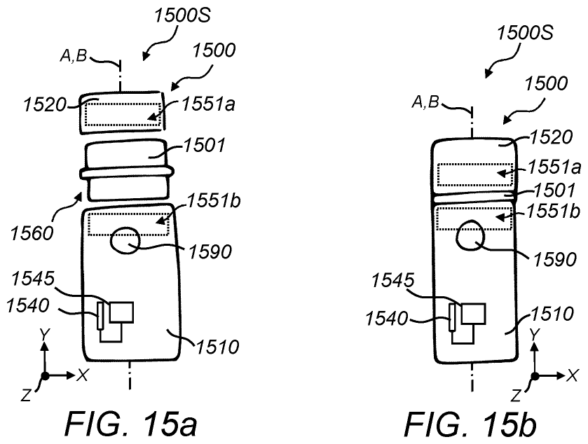

FIGS. 15a and 15b show an aerosol provision system 15005. The aerosol provision system 15005 comprises an aerosol provision device 1500 and an article 1501 for holding, aerosol-generating material. Similar components in the aerosol provision device 1500 and aerosol provision system 15005 have the same reference numbers as those of previous Figures but the reference numbers are increased by a multiple of 100. Such common features are not discussed in detail again. The discussion of aerosol provision system 15005 below is limited to the differences. The aerosol provision device 1500 may comprise features discussed previously that are compatible with the aerosol provision device 1500 but are not shown in FIGS. 15a and 15b. Non-exhaustive examples include a damping mechanism, a detector, a controller, a motor, a power source, and a switch.

The aerosol provision device 1500 comprises a first part 1510 and a second part 1520 and an accommodation zone for accommodating the article 1501. The first part 1510 and the second part 1520 are interconnected by the article 1501. In this embodiment, the accommodation zone is formed of two cavities 1551a, 1551b. The first part 1510 comprises a first cavity 1551a and the second part 1520 comprises a second cavity 1551b. The aerosol provision device 1500 comprises a coupling mechanism 1560 to moveably restrain the first part 1510 and second part 1520. In this embodiment, the coupling mechanism 1560 also moveably restrains the article 1501. That is, the coupling mechanism 1560 allows rotational movement of the first part 1510, second part 1520 and article 1501 relative to each other and about an axis A of the aerosol provision device 1500. Resistance to the rotational movement is provided by friction between the first part 1510 and the article 1501, and between the second part 1520 and the article 1501. In this embodiment, the axis B of the article 1501 is common with the axis A of the aerosol provision device 1500.

In this embodiment, the first part 1510 and the second part 1520 together occupy a first volume when the aerosol provision device 1500 is arranged in an unaccommodated state. When the two cavities 1551a, 1551b of the accommodation zone accommodates the article 1501 in an accommodated state of the aerosol provision device 1500, shown in FIG. 15b, the first part 1510 and the second part 1520 of the aerosol provision device 1500 together with the article 1501 occupy a second volume that is greater than the first volume. When coupled, the article 1501 forms a portion of an exterior of the aerosol provision device 15005. In this embodiment, the portion is a band.

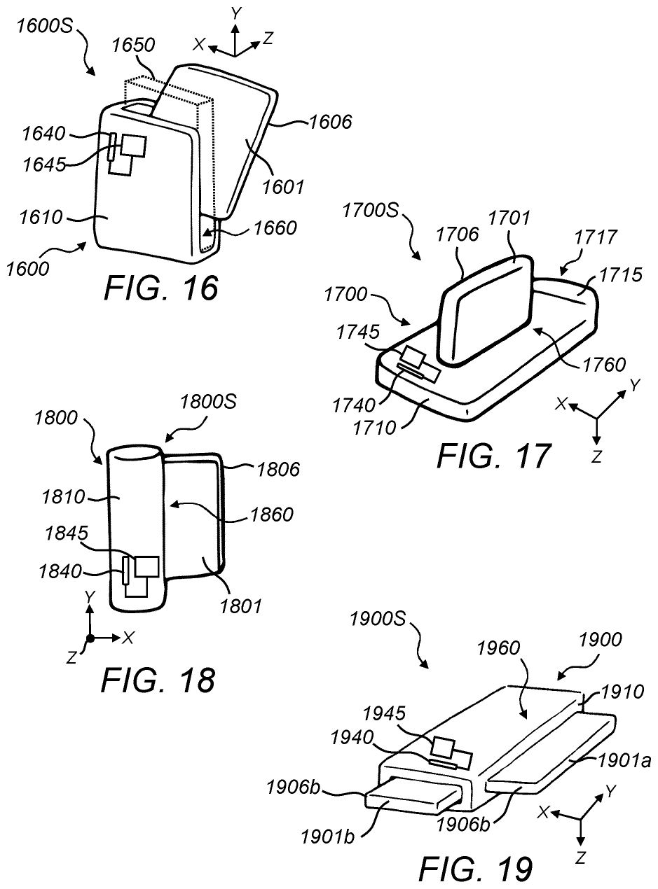

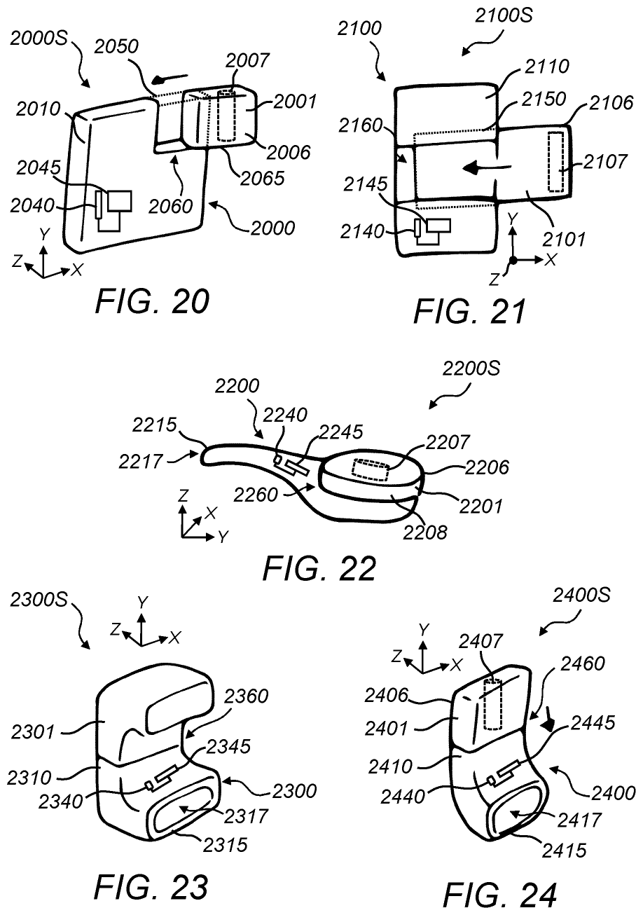

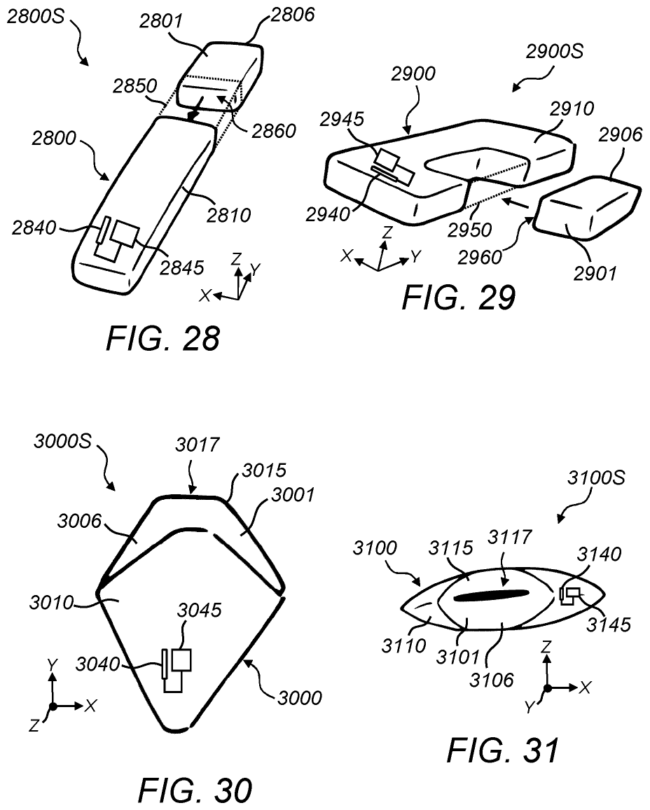

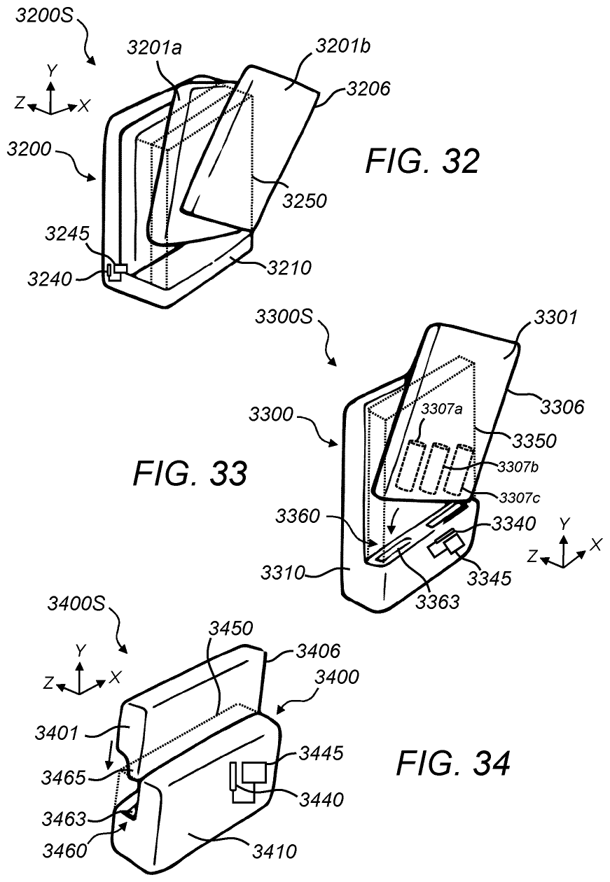

FIGS. 16-34 show aerosol provision systems 1600S, 1700S, 1800S, 1900S, 2000S, 2100S, 2200S, 2300S, 2400S, 2500S, 2600S, 2700S, 2800S, 2900S, 3000S, 3100S, 3200S, 3300S, 3400S. These aerosol provision systems comprise aerosol provision devices 1600, 1700, 1800, 1900, 2000, 2100, 2200, 2300, 2400, 2500, 2600, 2700, 2800, 2900, 3000, 3100, 3200, 3300, 3400 and articles 1601, 1701, 1801, 1901a, 1901b, 2001, 2101, 2201, 2301, 2401, 2801, 2901, 3001, 3101, 3201a, 3201b, 3301, 3401 or cartridges 2505, 2605, 2705. Similar components in these aerosol provision devices and aerosol provision systems have the same reference numbers as those of previous Figures but the reference numbers are increased by a multiple of 100. Such common features are not discussed in detail again. The discussion of these aerosol provision systems below is limited to the differences. These aerosol provision devices may comprise features discussed previously that are compatible with these aerosol provision devices but are not shown in the FIGS. 16-34. Non-exhaustive examples include a damping mechanism, a detector, a controller, a motor, a power source, and a switch.

Articles 1601, 1701, 1801, 1901a, 1901b, 2001, 2101, 2201, 2401, 2801, 2901, 3001, 3101, 3201a, 3201b, 3301, 3401 are planar articles. That is, a thickness of these articles (as measured in the depth direction Z for all articles or width direction X for article 1701) is significantly small compared to a width (as measured in the width direction X for all articles or depth direction Z for article 1701) and length (as measured in the length direction Y for all articles) of these articles. In some embodiments, article 2700, as shown in FIG. 27, may also be considered a planar article, such that a dimension of article 2700 in the depth direction Z is significantly smaller than a dimension of the article 2700 in a width direction X and in a length direction Y.

Each planar article 1601, 1701, 1801, 1901a, 1901b, 2001, 2101, 2201, 2401, 2801, 2901, 3001, 3101, 3201a, 3201b, 3301, 3401 comprises a storage portion 2007, 2107, 2207, 2407, 3307a-c. The storage portions comprise aerosol-generating material from which aerosol is to be generated by an aerosol generator 1640, 1740, 1840, 1940, 2040, 2140, 2240, 2440, 2840, 2940, 3040, 3140, 3240, 3340, 3440 of the aerosol provision device 1600, 1700, 1800, 1900, 2000, 2100, 2200, 2400, 2800, 2900, 3000, 3100, 3200, 3300, 3400. Each planar article comprises a coupling portion 2065, 3465 configured to become coupled with the respective aerosol provision device by a coupling mechanism 1660, 1760, 1860, 1960, 2060, 2160, 2260, 2360, 2460, 2860, 2960, 3260, 3360, 3460 to form the respective aerosol provision system 1601S, 1701S, 1801S, 1901S, 2001S, 2101S, 2201S, 2401S, 2801S, 2901S, 3000S, 3100S, 3201S, 3301S, 3401S. The planar articles comprise an outer surface 1606, 1706, 1806, 1906a, 1906b, 2006, 2106, 2206, 2406, 2806, 2906, 3006, 3106, 3206, 3306, 3406 comprising a minor dimension and configured to form a portion of an exterior of the aerosol provision system. The planar articles are configured such that when the articles are coupled to the respective aerosol provision devices by the respective coupling mechanisms, the minor dimension of the respective planar articles in a first direction is smaller than a dimension of the respective aerosol provision device in the first direction. In the embodiments, the minor dimension is at least one dimension of the planar articles in the width direction X, the depth direction Z or the length direction Y indicated in the Figures. The direction of the width, depth and length directions X, Z, Y as indicated in the Figures may be different to the actual width, depth, or length of the planar article shown in the Figures.

Most of the planar articles 1601, 1701, 1801, 1901a, 1901b, 2001, 2101, 2401, 2801, 2901, 3201a, 3201b, 3301, 3401 comprise a rectangular cross-section. However, planar article 2201 comprises a circular cross-section. Planar article 2201 comprises an arcuate outer edge 2208 that forms an outer surface of the aerosol provision system 2200S.

The planar articles 3001, 3101 of aerosol provision systems 3000S, 3101S comprise a mouthpiece 3015, 3115 having an opening 3017, 3117 through which a user is able to draw the aerosol, in use. Other articles or cartridges as previously described may also comprise such a mouthpiece. In some embodiments, such as aerosol provision systems 1700S, 2200S, 2400S the mouthpiece 1715, 2215, 2415 and opening 1717, 2217, 2417 are arranged in the aerosol provision device 1700, 2200, 2400. In aerosol provision device 1700, the mouthpiece 1715 is attached to and detachable from a body 1710. In aerosol provision device 2200, 2300, 2400, the mouthpiece 2215, 2300, 2415 is formed in the body 2210, 2310, 2410. The mouthpiece 2215 of aerosol provision device 2200 is formed in an elongated portion of the body 2200.

Aerosol provision systems 1900S, 3200S comprise two articles 1901a, 1901b, 3201a, 3201b. In some embodiments, the aerosol provision systems may comprise more than two articles. The two articles 1901a, 1901b in aerosol provision system 1900S are arranged in different respective sides of the aerosol provision device 1900. The two articles 3201a, 3201b in aerosol provision system 3200S are arranged side-by-side in the same side of the aerosol provision device 3200. A body 3210 of aerosol provision device 3200 is L-shaped in profile with an accommodation zone arranged in a corner of a space occupied by the aerosol provision system 3200S. A body 1910 of aerosol provision device 1900 is a cuboid with rectangular cross-sections.

In aerosol provision systems 1700S, 1800S, 1900S, the planar article 1701, 1801, 1901a extends from the body 1710, 1810, 1910 of the aerosol provision device 1700, 1800, 1900 in a perpendicular direction to a longitudinal direction Y of the aerosol provision device. In aerosol provision systems 1700S, 1800S an amount of extension is greater than a dimension of the body 1710, 1810 in a direction of extension.

In planar article 3301, three discrete zones 3307a-c are shown. Each of the three discrete zones 3307a-c is configured to receive a discrete portion of the aerosol-generating material. In other embodiments, more or less than three discrete zones may be provided. In planar article 3301, the discrete zones 3307a-c are spaced apart in a width direction X and extend along a portion of the planar article 3301 in the length direction Y.

An accommodation zone 3350, 3450 of each of aerosol provision device 3300, 3400 is provided over recesses 3363, 3463 of a snap fit mechanism 3360. In aerosol provision device 3300, the snap fit mechanism comprises two flexible protrusions of the article 3301 that are each engageable with two recesses 3363. In aerosol provision device 3400, the snap fit mechanism comprises a single flexible protrusion of the article 3401 that is engageable with a single recess 3463 of the aerosol provision device 3400. In some embodiments, the aerosol provision device may comprise the flexible protrusion and the article may comprise the recess.

In aerosol provision system 2000S, the article 2001 is coupled to a corner of the aerosol provision device 2000. That is, an accommodation zone 2050 is located at a corner of the aerosol provision device 2000 and is formed by an absent space of a corner the body 2010. In aerosol provision system 2100S, 2900S, the article 2101, 2901 is coupled to a middle of the aerosol provision device 2000, 2900. That is, an accommodation zone 2150, 2950 is located midway along a dimension of the aerosol provision device 2100, 2900 and is formed by an absent space at a middle of the body 2110, 2910. In aerosol provision system 2800S, the article 2801 is coupled to an end of the aerosol provision device 2800. That is, an accommodation zone 2850 is located at an end of the aerosol provision device 2800 and is formed by an absent end space of the body 2810.

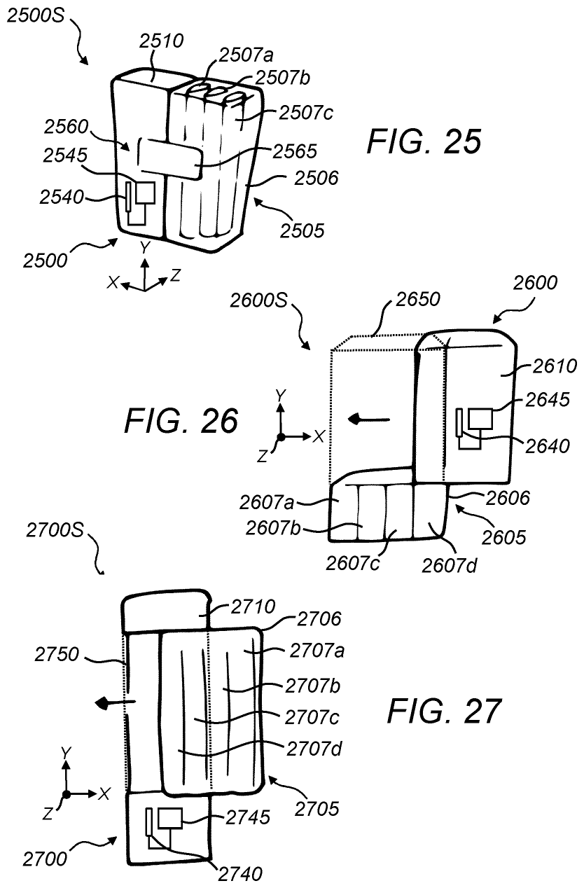

Referring to FIGS. 25 to 27, the aerosol provision systems 2500S, 2600S, 2700S comprise cartridges 2505, 2605, 2705 that are couplable with aerosol provision devices 2500, 2600, 2700. Each cartridge 2505, 2605, 2705 comprises three or four discrete zones 2507a-c, 2607a-d, 2707a-d. Each of the cartridges 2505, 2605, 2705 comprises an outer surface 2506, 2606, 2706 that forms a portion of an exterior of the aerosol provision system 2500S, 2600S, 2700S. Each of the cartridges 2505, 2605, 2705 engages with a body 2510, 2610, 2710 of the aerosol provision devices 2500, 2600, 2700. In aerosol provision devices 2500, the coupling mechanism 2560 comprises a flexible protrusion 2565 that is engageable with a recess of the cartridge 2505.

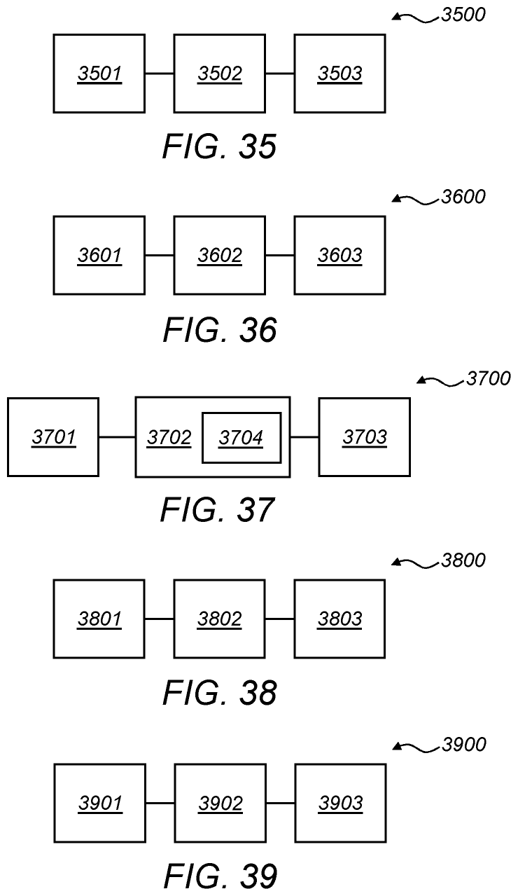

FIG. 35 shows an illustration of a method 3500 of forming an aerosol provision system. The method 3500 comprises providing 3501 an article comprising, or configured to hold, aerosol-generating material. The method 3500 comprises providing 3502 an aerosol provision device couplable to the article and comprising an aerosol generator for generating aerosol from the aerosol-generating material, wherein the aerosol provision device comprises a minor dimension in a first direction. The method 3500 comprises coupling 3503 the aerosol provision device to the article by a coupling mechanism such that, a value of a dimension of the aerosol provision system in the first direction exceeds a value of the minor dimension of the aerosol provision device as a result of a presence of the article at one end of the minor dimension.

FIG. 36 shows an illustration of a method 3600 of forming an aerosol provision system. The method 3600 comprises providing 3601 a planar article comprising, or configured to receive, aerosol-generating material from which aerosol is to be generated by an aerosol generator, wherein the planar article comprises an outer surface having a minor dimension and configured to form a portion of an exterior of the aerosol provision system. The method 3600 comprises providing 3602 an aerosol provision device couplable to the planar article by a coupling mechanism and comprising the aerosol generator. The method 3600 comprises coupling 3603 the aerosol provision device to the planar article such that the minor dimension of the planar article in a first direction is smaller than a dimension of the aerosol provision device in the first direction.

FIG. 37 shows an illustration of a method 3700 of forming an aerosol provision system. The method 3700 comprises providing 3701 an aerosol provision device comprising an aerosol generator for generating aerosol from aerosol-generating material, and a selector configured to select a discrete portion of the aerosol-generating material. The method 3700 comprises accommodating 3702 the discrete portion of aerosol-generating material in one of a plurality of accommodation zones. The method 3700 comprises selectively moving 3703 the selector relative to the plurality of accommodation zones such that the discrete portion of aerosol-generating material is selected by the selector to generate aerosol from the discrete portion of aerosol-generating material. In this embodiment, the accommodating 3702 comprises accommodating 3704 the discrete portion of aerosol-generating material in a cavity comprising one of the plurality of accommodation zones. In other embodiments, the accommodating comprises accommodating the discrete portion of aerosol-generating material in a cavity comprising the plurality of accommodation zones.

FIG. 38 shows an illustration of a method 3800 of forming an aerosol provision system. The method 3800 comprises providing 3801 an article comprising, or for holding, aerosol-generating material. The method 3800 comprises providing 3802 an aerosol provision device in the shape of an annulus and comprising an aerosol generator for generating aerosol from the aerosol-generating material. The method 3800 comprises coupling 3803 the aerosol provision device to the article such that the article forms part of an external surface of the aerosol provision system.

FIG. 39 shows an illustration of a method 3900 of forming an aerosol provision system. The method 3900 comprises providing 3901 an article comprising, or for holding, aerosol-generating material. The method 3900 comprises providing 3902 an aerosol provision device couplable to the article and comprising an aerosol generator for generating aerosol from the aerosol-generating material. The method 3900 comprises coupling 3903 the aerosol provision device to the article such that, when viewed in a first direction, the aerosol provision system occupies a first space formed of a plurality of substantially equal spaces, and the article occupies a second space corresponding to a majority portion of one of the plurality of substantially equal spaces, wherein the first space has an order of rotational symmetry greater than two.

Aerosol provision devices and/or articles as previously described, can be used, where discussed, in operation of any one of the methods as previously described.

Embodiments of the present disclosure comprise an aerosol provision device, an aerosol provision system comprising an aerosol provision device and an article comprising, or for holding, aerosol-generating material, and a methods of forming an aerosol provision system. The consumable is for receipt in the chamber of the aerosol provision device. In use, the aerosol provision devices are configured to generate an inhalable medium, such as aerosol, from the aerosol-generating material.

For the avoidance of doubt, where in this specification the term “comprises” is used in defining the invention or features of the invention, embodiments are also disclosed in which the invention or feature can be defined using the terms “consists essentially of” or “consists of” in place of “comprises”. Reference to a material “comprising” certain features means that those features are included in, contained in, or held within the material.

The above embodiments are to be understood as illustrative examples of the disclosure. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

The various embodiments described herein are presented only to assist in understanding and teaching the claimed features. These embodiments are provided as a representative sample of embodiments only and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized, and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol provision device comprising:
an aerosol generator for generating aerosol from aerosol-generating material;
a first coupling mechanism;
a first part and a second part moveably restrained with respect to each other by the first coupling mechanism; and
an accommodation zone, formed by the first part and the second part, for accommodating an article comprising, or for holding, the aerosol-generating material;
wherein the first part and the second part together occupy a first volume when the aerosol provision device is arranged in an unaccommodated state, and when the accommodation zone accommodates the article in an accommodated state of the aerosol provision device, the first part and the second part of the aerosol provision device together with the article occupy a second volume that is greater than the first volume.

2. The aerosol provision device according to claim 1, wherein the first part and the second part are relatively moveable about a pivot.

3. The aerosol provision device according to claim 2, wherein the pivot is substantially parallel to a direction of a major dimension of the aerosol provision device.

4. The aerosol provision device according to claim 2, wherein the pivot is substantially parallel to a direction of a minor dimension of the aerosol provision device.

5. The aerosol provision device according to claim 2, comprising a hinge, wherein the hinge comprises the pivot.

6. The aerosol provision device according to claim 2, comprising a flexible member, wherein the flexible member comprises the pivot.

7. The aerosol provision device according to claim 1, comprising a mechanism configured to bias the aerosol provision device towards the unaccommodated state by urging the first part and the second part together.

8. The aerosol provision device according to claim 7, wherein the first coupling mechanism comprises the mechanism.

9. The aerosol provision device according to claim 8, wherein the first coupling mechanism is configured to moveably restrain the article when the article is accommodated by the accommodation zone when the aerosol provision device is in the accommodated state.

10. The aerosol provision device according to claim 1, wherein the aerosol provision device is configured to moveably restrain the article by a second coupling mechanism.

11. The aerosol provision device according to claim 10, wherein the second coupling mechanism comprises a coupling of a first portion of the aerosol provision device with a first portion of the article.

12. The aerosol provision device according to claim 10, wherein the second coupling mechanism comprises a coupling of a second portion of the aerosol provision device with a second portion of the article.

13. The aerosol provision device according to claim 1, wherein the aerosol provision device is substantially annular.

14. (canceled)

15. The aerosol provision device according to claim 1, wherein, when the article is accommodated by the accommodation zone when the aerosol provision device is in the accommodated state, the aerosol provision device and the article form an aerosol provision system, wherein the accommodation zone is located in a central region of the aerosol provision system.

16. The aerosol provision device according to claim 15, wherein the accommodation zone is located longitudinally of the aerosol provision system.

17. (canceled)

18. The aerosol provision device according to claim 1, wherein the accommodation zone is variable in size, wherein the size of the accommodation zone is dependent on a relative position of the first part and the second part.

19. (canceled)

20. (canceled)

21. The aerosol provision device according to claim 1, wherein the first part and the second part are detachable from each other.

22. An article for use with the aerosol provision device according to claim 1, wherein the article comprises, or holds, the aerosol-generating material.

23. An aerosol provision system comprising the aerosol provision device according to claim 1 and an article that comprises, or holds, the aerosol-generating material.

24. A method of forming an aerosol provision system, the method comprising:
providing an article comprising, or for holding, aerosol-generating material;
providing an aerosol provision device for accommodating the article, wherein the aerosol provision device comprises:
an aerosol generator for generating aerosol from the aerosol-generating material;
a first coupling mechanism;
a first part;
a second part; and
an accommodation zone, formed by the first part and the second part, for accommodating the article;
restraining the first part and the second part with respect to each other by the first coupling mechanism such that the first part and the second part together occupy a first volume in an unaccommodated state of the aerosol provision device; and
accommodating the article in the accommodation zone in an accommodated state of the aerosol provision device, such that the first part and the second part of the aerosol provision device together with the article occupy a second volume that is greater than the first volume.
